(19) United States
(12) Patent Application Publication
(10) Pub. No.: US 2014/0337789 A1
(43) Pub. Date: Nov. 13, 2014

(54) DISPLAY PROCESSING APPARATUS, SYSTEM AND STORAGE MEDIUM STORING DISPLAY PROCESSING PROGRAM

(71) Applicant: FUJITSU LIMITED, Kawasaki-shi (JP)

(72) Inventors: Hidehiko Mayumi, Kawasaki (JP); Toshio Tanaka, Yokohama (JP); Takeaki Kobayashi, Yokohama (JP); Masahiro Kawasaki, Kawasaki (JP)

(73) Assignee: FUJITSU LIMITED, Kawasaki-shi (JP)

(21) Appl. No.: 14/242,300

(22) Filed: Apr. 1, 2014

(30) Foreign Application Priority Data
May 10, 2013 (JP) 2013-100746

(51) Int. Cl. G06F 3/0488; G06F 3/0482

(52) U.S. Cl. CPC G06F 3/04883; G06F 3/0482
USPC 715/781

(57) ABSTRACT

A display processing apparatus includes a reception unit configured to receive an input of a symbol when each of a plurality of data is disposed and displayed on a different area among display areas by a display device; a registration unit configured to register a group of data according to a position and/or a shape of the symbol in the display area among data included in the plurality of data when the symbol is received by the reception unit; and a display control unit configured to control the display device to display other data included in the group of data, when any of data included in the plurality of data is designated and the designated data is included in the registered group of data, together with the designated data.

### CROSS-REFERENCE TO RELATED APPLICATION

This application is based upon and claims the benefit of priority from the prior Japanese Patent Application No. 2013-100746 filed on May 10, 2013, the entire content of which are incorporated herein by reference.

### FIELD

The present disclosure relates to a display processing apparatus, a system and a display processing program.

### BACKGROUND

Many classes are being conducted using mobile terminals, such as a slate terminal, in which a handwriting input is performed by a touch pen or finger, and it is anticipated that these types of classes will be more widely distributed.

There is a relevant technology in which an image display apparatus constituted by a display unit and a touch panel displays a plurality of corresponding images, along with an image surrounding the plurality of images, when the touch panel corresponding to the plurality of images displayed in the display unit is manipulated.

Further, there is a technology in which an area surrounded by a circular locus of bright spots of a pointer is displayed in an enlarged scale when an indication position of a pointer is moved by a user into a right direction to surround a portion of a screen-shaped projected image.

There is also a technology in which a projector generates a zoom image in which a portion of an image is highlighted and an area including the highlighted portion is enlarged, and projects the generated zoom image, based on indication information input by a user.

See, for example, Japanese Patent Application Laid-Open No. 2010-113441, Japanese Patent Application Laid-Open No. 2011-81651, and Japanese Patent Application Laid-Open No. 2007-219217.

Following class type may be considered as the class type using the mobile terminal provided with a handwriting input function as described above. For example, an assignment is transmitted from a teacher's terminal to a student's terminal and an opinion about the assignment is input to the student's terminal by the student. Also, the student's terminal transmits the input opinion to the teacher's terminal. When the opinions transmitted from the student's terminal are integrated by a teacher, the teacher's terminal may display a plurality of integrated opinions in a matrix shape on an electronic blackboard connected to the teacher's terminal. Also, the teacher causes the student to conduct a discussion about the opinion while displaying the opinion on the screen.

However, it is inconvenient to display the information on dividing opinions into groups to be overlapped on the plurality of opinions in the class type, as described above. For example, it may be considered that a symbol connecting or surrounding opinions interrelated with each other is displayed to be overlapped on a plurality of opinions by, for example, a touch pen in order to associate the plurality of opinions displayed in a matrix shape with each other in the class type described above. Also, in a case of displaying the symbol to be overlapped on the plurality of opinions, the teacher needs to sequentially select the plurality of opinions when the plurality of associated opinions is displayed in an enlarged scale in order to set the plurality of opinions to be associated as a target to be discussed. Therefore, though a plurality of opinions are associated with each other by the handwriting input as described above, there is a problem in that it is inconvenient for a teacher, for example, a plurality of interrelated opinions may not be displayed concurrently in an enlarged scale. Further, such a problem is not limited to a case of displaying the plurality of interrelated opinions in an enlarged scale, and may also similarly occur in a case of simply displaying a plurality of data.

### SUMMARY

According to one aspect of the embodiments, there is provided a display processing apparatus including a reception unit configured to receive an input of a symbol when each of a plurality of data is disposed and displayed on a different area among display areas by a display device; a registration unit configured to register a group of data according to a position and/or a shape of the symbol in the display area among data included in the plurality of data when the symbol is received by the reception unit; and a display control unit configured to control the display device to display other data included in the group of data, when any of data included in the plurality of data is designated and the designated data is included in the registered group of data, together with the designated data.

The object and advantages of the disclosure will be realized and attained by the elements and combinations particularly pointed out in the claims. It is to be understood that both the foregoing general descriptions and the following detailed descriptions are exemplary and explanatory, and are not restrictive of the invention, as claimed.

### BRIEF DESCRIPTION OF DRAWINGS

FIG. 1 is a view illustrating an exemplary configuration of a system according to an exemplary embodiment of the present disclosure.

FIG. 2 is a view illustrating an exemplary functional configuration of a teacher terminal.

FIG. 3 is a view illustrating an exemplary data structure of a student DB.

FIG. 4 is a view illustrating an exemplary data structure of an assignment DB.

FIG. 5 is a view illustrating an exemplary data structure of an assignment reply DB.

FIG. 6 is a view illustrating an exemplary data structure of a handwriting mark coordinate DB.

FIG. 7 is a view for explaining an example of an assignment selection screen generation method.

FIG. 8 is a view illustrating an example of a displayed content when a selection result, a content of opinion and a student name are displayed on a display unit or an electronic blackboard in a matrix shape.

FIG. 9 is a view for explaining a process of determining as to whether a handwriting input is done.

FIG. 10 is a view for explaining a mark which repeats a minute increase or decrease.

FIG. 11 is a view for explaining a process of changing a line segment of mark into a broken line.

FIG. 12 is a view illustrating another example of a displayed content when a selection result, a content of opinion and a student name are displayed on a display unit or an electronic blackboard in an enlarged scale.

FIG. 13 is a view illustrating another example of a displayed content when a selection result, a content of opinion and a student name are displayed on a display unit or an electronic blackboard in an enlarged scale.

FIG. 14 is a view illustrating another example of a displayed content when a selection result, a content of opinion and a student name are displayed on a display unit or an electronic blackboard in an enlarged scale.

FIG. 15 is a view illustrating another example of a displayed content when a selection result, a content of opinion and a student name are displayed on a display unit or an electronic blackboard in an enlarged scale.

FIG. 16 is a view illustrating another example of a displayed content when a selection result, a content of opinion and a student name are displayed on a display unit or an electronic blackboard in an enlarged scale.

FIG. 17 is a view illustrating an exemplary functional configuration of a student terminal.

FIG. 18 is a view illustrating an exemplary reply screen.

FIG. 19A and FIG. 19B are flowcharts illustrating a procedural sequence of a display process according to an embodiment.

FIG. 20 is a flowchart illustrating a procedural sequence of a handwriting display process according to an embodiment.

FIG. 21A and FIG. 21B are flowcharts illustrating a procedural sequence of an erasure process according to an embodiment.

FIG. 22 is a flowchart illustrating a sequence of an opinion display process according to an embodiment.

FIG. 23 is a view illustrating a computer that executes a display processing program.

### DESCRIPTION OF EMBODIMENTS

Hereinbelow, exemplary embodiments of a display processing apparatus, a system and a display processing program disclosed in the present disclosure will be described in detail with reference to drawings. Further, the embodiments are not intended to limit the disclosed technique.

### Embodiment

[Example of System Configuration]

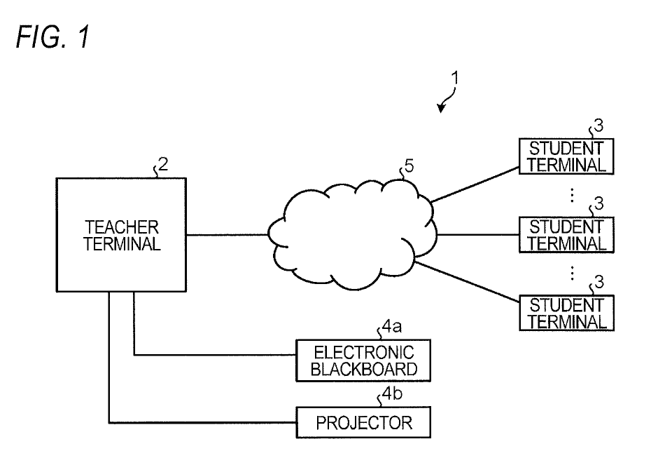

Descriptions will be made on a system according to an exemplary embodiment. FIG. 1 is a view illustrating an exemplary configuration of the system according to the embodiment. As illustrated in FIG. 1, the system 1 includes a teacher terminal 2, a plurality of student terminals 3, an electronic blackboard 4a and a projector 4b. The teacher terminal 2 and the plurality of student terminals 3 are connected with each other through, for example, a network 5. Accordingly, the teacher terminal 2 and the plurality of student terminals 3 may be communicated with each other. The network 5 may include any communication network such as the Internet, LAN (Local Area Network) or VPN (Virtual Local Network), irrespective of wired or wireless communication network.

The electronic blackboard 4a displays an image output from the projector 4b. The projector 4b controls the electronic blackboard 4a to display a predetermined image.

In the system 1 according to the embodiment, the teacher terminal 2 which is a terminal used by a teacher who conducts a class is manipulated to transmit an assignment to each of the plurality of student terminals 3 that correspond to the plurality of terminals used by each of a plurality of students who attend in the class conducted by the teacher. Then, the system 1 may be prompted such that the teacher terminal 2 transmits the assignment to the student terminal 3. Also, when an opinion about the assignment is input by the student, the student terminal 3 transmits the opinion input by the student to the teacher terminal 2 in the system 1. Also, in the system 1, the teacher terminal 2 integrates and transmits the opinions received from the student terminal 3 to the projector 4b or the student terminal 3 to display the opinions on the electronic blackboard 4a or the student terminal 3 in a matrix shape. By doing this, the teacher may conduct a class in which the students are requested to conduct discussions about the opinions while displaying the opinions on the electronic blackboard 4a or the student terminal 3.

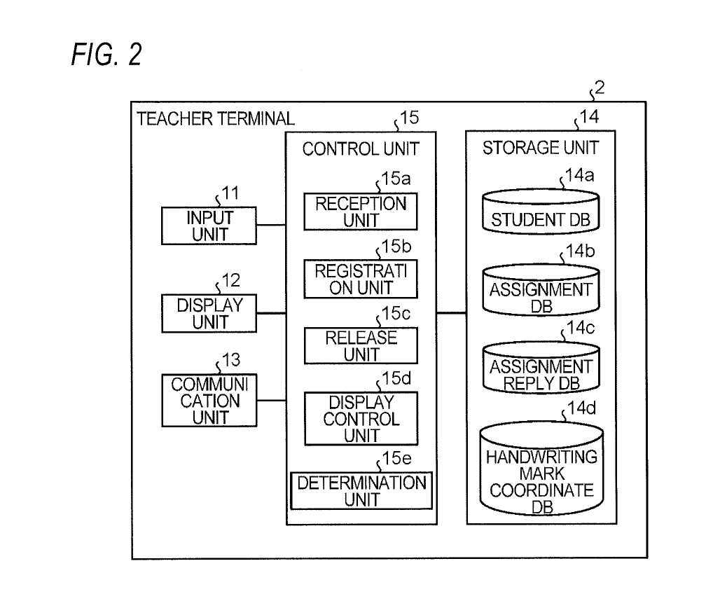

The teacher terminal 2 may be a variety of terminals including, for example, a mobile terminal such as a slate terminal. The teacher terminal 2 is used by the teacher who conducts class as described above. FIG. 2 is a view illustrating an exemplary functional configuration of the teacher terminal. As illustrated in the example of FIG. 2, the teacher terminal 2 includes an input unit 11, a display unit 12, a communication unit 13, a storage unit 14 and a control unit 15.

The input unit 11 inputs various information to the control unit 15. For example, the input unit 11 is a touch panel provided on the display unit 12, and receives input signal of a touch pen or a finger manipulated by the teacher who conducts the class and input the received signal to the control unit 15. An example of such manipulation of the touch pen may include, for example, drawing a mark to be described below or executing a display control process to be described below.

The display unit 12 displays various information. For example, the display unit 12 displays an assignment selection screen to be described below by the control of the reception unit 15a to be described below. An example of a device of the display unit 12 may include, for example, a liquid crystal display.

The communication unit 13 is a communication interface for allowing the teacher terminal 2, the student terminal 3, the electronic blackboard 4a and the projector 4b to communicate with each other.

The storage unit 14 stores various information. For example, the storage unit 14 stores a student database 14a, an assignment database 14b, an assignment reply database 14c and a handwriting mark coordinate database 14d. Hereinbelow, a database is abbreviated to “DB”.

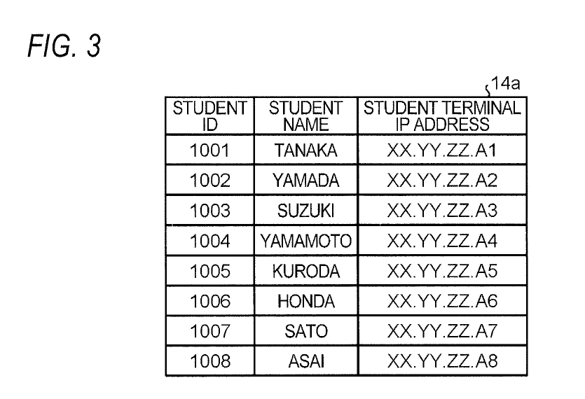

Various information of students who attend in a class are registered in the student DB 14a. FIG. 3 is a view illustrating an exemplary data structure of a student DB. As illustrated in the example of FIG. 3, the student DB 14a includes fields for a “student ID (Identification)”, a “student name” and a “student terminal IP (Internet Protocol) address”. An ID for identifying a student is registered in the “student ID” field in advance. A family name of a student identified by the ID registered in the “student ID” field is registered in the “student name” field in advance. An IP address of the student terminal 3 used by the student identified by the ID registered in the “student ID” field is registered in the “student terminal IP address” field.

For example, a first record of the student DB 14a illustrated in the example of FIG. 3 indicates that the family name identified by the ID “1001” is “Tanaka” and the IP address of the student terminal 3 used by the student “Tanaka” is “XX.YY.ZZ.A1”. The same rule applies with other records of the student DB 14a.

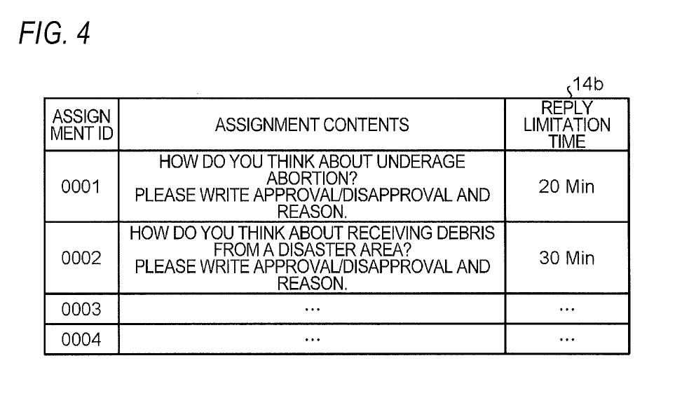

Referring to the description of FIG. 2, information on an assignment presented by a teacher to a student is registered in the assignment DB 14b. FIG. 4 is a view illustrating an exemplary data structure of an assignment DB. As illustrated in an example of FIG. 4, an assignment DB 14b includes fields for an “assignment ID”, an “assignment content” and a “reply limitation time”. An ID for identifying an assignment is registered in the “assignment ID” field in advance. The content of the assignment identified by the ID registered in the “assignment ID” field is registered in the “assignment content” field in advance. The limitation time indicating a time until a reply is received from a student after an assignment identified by the ID registered in the “assignment ID” field is presented to the student is registered in the “reply limitation time” field in advance. That is, the limitation time means that the student is required to transmit a reply within a limitation time.

For example, a first record of the student DB 14a illustrated in the example of FIG. 4 indicates that the content of the assignment identified by the ID “0001” is “How do you think about underage abortion? Please write approval or disapproval and reason.”. Additionally, the first record of the student DB 14a illustrated in the example of FIG. 4 indicates that a time (limitation time) until a reply is received from a student after an assignment identified by the ID “0001” is presented to the student is “20 minutes”. The same rule applies with other records of the student DB 14b.

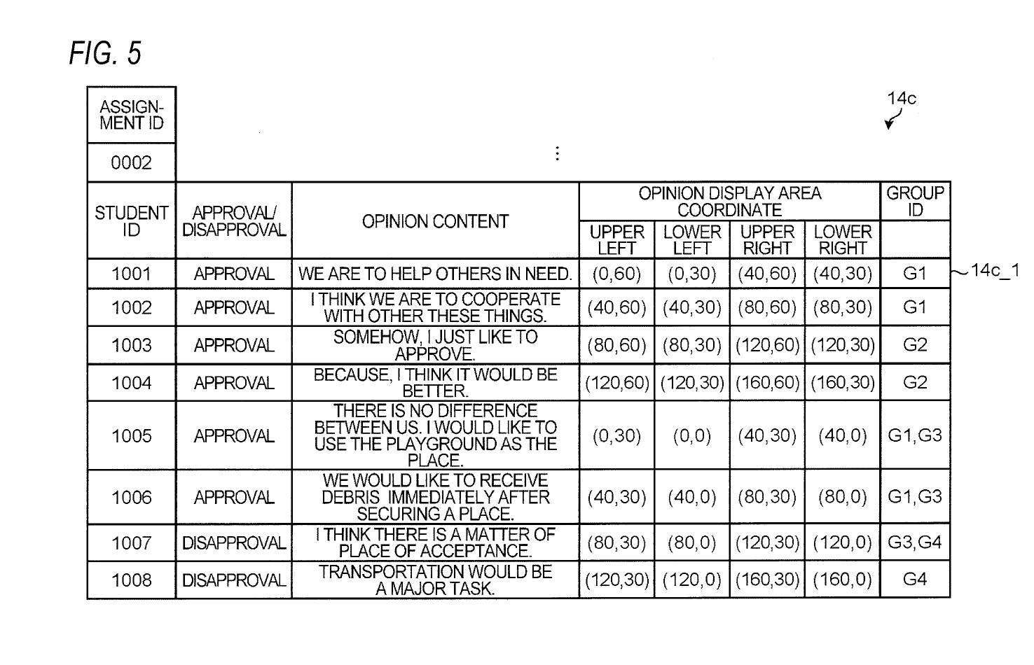

Referring to the description of FIG. 2, the assignment reply DB 14c includes a table in which various information on the reply of student about an assignment for each assignment are registered. FIG. 5 is a view illustrating an exemplary data structure of an assignment reply DB. As illustrated in an example of FIG. 5, the assignment reply DB 14c includes a table 14c_1 in which the reply of student about the assignment for each assignment is registered. The table 14c_1 includes fields for an “assignment ID”, a “student ID”, an “approval/disapproval”, an “opinion content”, an “opinion display area coordinate” and a “group ID”. An ID for identifying an assignment is registered in the “assignment ID” field by the reception unit 15a to be described below. An ID of the student who replies an opinion about the assignment identified by the ID registered in the “assignment ID” field is registered in the “student ID” field by the reception unit 15a. The content of approval or disapproval replied by the student identified by the ID registered in the “student ID” field is registered in an “approval/disapproval” field by the reception unit 15a as an approval or disapproval about the assignment identified by the ID registered in the “assignment ID” field. The content of opinion replied by the student identified by the ID registered in the “student ID” field is registered in an “opinion content” field by the reception unit 15a, as an opinion content of the assignment identified by the ID registered in the “assignment ID” field.

The “opinion display area coordinate” field includes an “upper left” field, a “lower left” field, an “upper right” field and a “lower right” field. In the “upper left” field, when a plurality of opinions are displayed in a matrix shape to be described below, a coordinate of a an upper left position of an area in which an opinion of the student identified by an ID registered in the “student ID” field is displayed is registered by the reception unit 15a. In the “lower left” field, when a plurality of opinions are displayed in a matrix shape, a coordinate of a lower left position of an area in which an opinion of the student identified by an ID registered in the “student ID” field is displayed is registered by the reception unit 15a. In the “upper right” field, when a plurality of opinions are displayed in a matrix shape, a coordinate of an upper right position of an area in which an opinion of the student identified by an ID registered in the “student ID” field is displayed is registered by the reception unit 15a. In the “lower right” field, when a plurality of opinions are displayed in a matrix shape, a coordinate of a lower right position of an area in which an opinion of the student identified by an ID registered in the “student ID” field is displayed is registered by the reception unit 15a.

In the “group ID” field, the same ID of the group is registered by the registration unit 15b to be described below with respect to the plurality of opinions interrelated by the teacher.

For example, the table 14c_1 illustrated in an example of FIG. 5 indicates a table in which the reply of the student about the assignment “How do you think about receiving debris from a disaster area?” identified by the ID “0002” is registered. Further, a first record of the table 14c_1 illustrated in the example of FIG. 5 indicates that the student “Tanaka” identified by the ID “1001” has an opinion of “approval” about “receiving debris” about the assignment of “How do you think about receiving debris from a disaster area?”. Further, the first record of the table 14c_1 illustrated in the example of FIG. 5 indicates that the student “Tanaka” has replied an opinion content of “We are to help someone in need” about the assignment of “How do you think about receiving debris from a disaster area?” Furthermore, the first record of the table 14c_1 illustrated in the example of FIG. 5 indicates that the coordinate of the upper left position is (0, 60), the coordinate of the lower left position is (0, 30), and the coordinate of the upper right position is (40, 60), in an area in which an opinion replied by the student “Tanaka” is displayed. Furthermore, the first record of the table 14c_1 illustrated in the example of FIG. 5 indicates that the coordinate of the lower right position is (40, 30), in an area in which an opinion replied by the student “Tanaka” is displayed and the opinion replied by the student “Tanaka” belongs to a group identified by an ID “G1”. The same rule applies with other records of the table.

Referring back to the description of FIG. 2, a mark for interrelating a plurality of opinions with each other, that is, various information of a mark for setting a plurality of opinions to be belonged to the same group are registered in a handwriting mark coordinate DB 14d. Here, the mark is also referred to as a symbol. Further, as will be described below, the mark is drawn on the display unit 12 by a teacher.

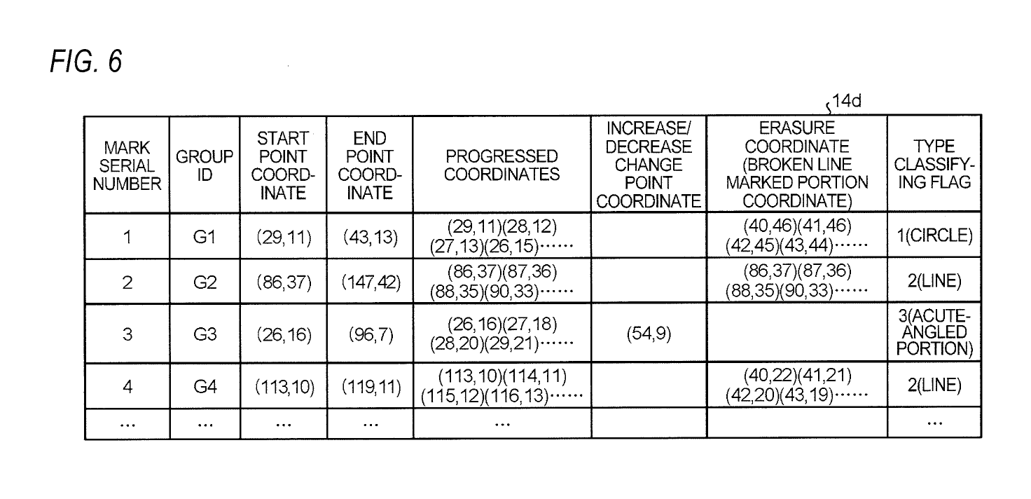

FIG. 6 is a view illustrating an exemplary data structure of a handwriting mark coordinate DB. As illustrated in the example of FIG. 6, the handwriting mark coordinate DB 14d includes fields for a “mark serial number”, a “group ID”, a “start point coordinate”, an “end point coordinate”, a “progressed coordinate”, an “increase/decrease change point coordinate”, an “erasure coordinate (broken line representation portion coordinate)” and a “type classifying flag”.

A number for identifying a mark is registered in the “mark serial number” field by the reception unit 15a. An ID of the group to which the mark identified by the number registered in the “mark serial number” field belongs is registered in the “group ID” field by the reception unit 15a. The coordinate of the start point of the mark identified by the number registered in the “mark serial number” field is registered in the “start point coordinate” field by the reception unit 15a. The coordinate of the end point of the mark identified by the number registered in the “mark serial number” field is registered in the “end point coordinate” field by the reception unit 15a. Coordinates of points between the start point and the end point of the mark identified by the number registered in the “mark serial number” field are registered in the “progressed coordinates” by the reception unit 15a. A coordinate of the increase/decrease change point included in the mark identified by the number registered in the “mark serial number” field is registered in the “increase/decrease change point coordinate” field by the reception unit 15a. A group of coordinates that becomes an erasure coordinate to be described below is registered in the “erasure coordinate” by the reception unit 15a. A flag indicating a type of a shape of a mark identified by the number registered in the “mark serial number” field is registered in the “a type classifying flag” field by the reception unit 15a. Here, for example, when a value of a flag is “1”, the flag indicates that the shape of the mark is a circle. Further, when the value of the flag is “2”, the flag indicates that the shape of the mark is a line. Further, when the value of the flag is “3”, the flag indicates that the shape of the mark is a line including an acute-angled portion to be described below.

For example, a first record of the handwriting mark coordinate DB 14d illustrated in the example of FIG. 6 indicates that the mark identified by the number “1” belongs to a group identified by an ID “G1”. Further, the first record of the handwriting mark coordinate DB 14d illustrated in the example of FIG. 6 indicates that a coordinate of a start point and a coordinate of an end point of the mark identified by the number “1” are (29, 11) and (43, 13), respectively. Further, the first record of the handwriting mark coordinate DB 14d illustrated in the example of FIG. 6 indicates that coordinates of points between the start point and the end point of the mark identified by the number “1” are (29, 11), (28, 12), (27, 13), (26, 15) . . . . The first record of the handwriting mark coordinate DB 14d illustrated in the example of FIG. 6 indicates that an increase/decrease change point is not included in the mark identified by the number “1”. Further, the first record of the handwriting mark coordinate DB 14d illustrated in the example of FIG. 6 indicates that erasure coordinates of points of the mark identified by the number “1” are (40, 46), (41, 46), (42, 45), (43, 44)) . . . . Further, the first record of the handwriting mark coordinate DB 14d illustrated in the example of FIG. 6 indicates that the shape of the mark identified by the number “1” is a shape similar to a circle identified by the value “1” of the flag. The same rule applies with other records.

Referring back to the description of FIG. 2, the storage unit 14 may be a storage device including, for example, a semiconductor memory device such as a flash memory, or a hard disk or an optical disk. Further, the storage unit 14 is not limited to the above-described type of storage device, but may include a RAM (Random Access Memory) or a ROM (Read Only Memory).

The control unit 15 includes an internal memory for storing control data or a program in which various processing sequences are defined, and executes various processes by the program and the control data. As illustrated in FIG. 2, the control unit 15 includes a reception unit 15a, a registration unit 15b, a release unit 15c, a display control unit 15d and a determination unit 15e.

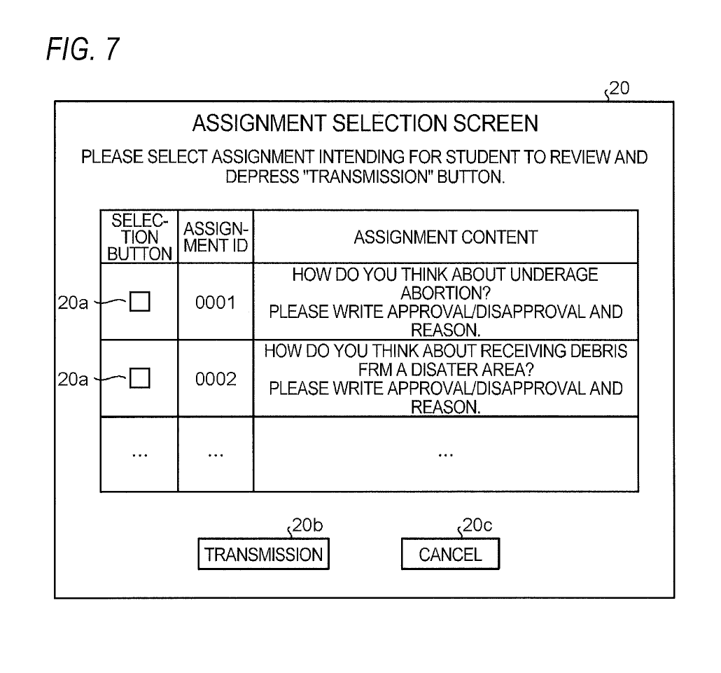

The reception unit 15a receives a mark for interrelating opinions with each other. One aspect of the reception unit 15a will be described. For example, the reception unit 15a generates an assignment selection screen and controls the display unit 12 to display the generated assignment selection screen when an instruction to execute a display process is input from the input unit 11. An example of an assignment selection screen generation method by the reception unit 15a will be described. FIG. 7 is a view for explaining an example of an assignment selection screen generation method. When generating the assignment selection screen, the reception unit 15a first acquires all of the IDs and the contents of the assignments registered in the assignment DB 14b. Also, the reception unit 15a, as illustrated in an example of FIG. 7, registers the acquired ID and the contents of the assignments in the “assignment ID” field and the “assignment content” field of the assignment selection screen 20 by associating the acquired ID of the assignments with the acquired contents of the assignments, respectively. Further, as illustrated in the example of FIG. 7, the reception unit 15a prepares a check box 20a in a “selection button” field of the assignment selection screen 20 by associating the check box 20a with the “assignment ID” field and the “assignment content” field. The user manipulates the input unit 11 to check the check box 20a. For example, when the check box 20a associated with a second record of the assignment selection screen 20 illustrated in the example of FIG. 7 is checked, the checked check box 20a indicates the following matters. That is, the check box 20a indicates that an assignment of which content is “How do you think about receiving debris from a disaster area? Please write approval or disapproval and reason” is selected as the assignment identified by the ID “0002”. Further, as illustrated in an example of FIG. 7, the reception unit 15a prepares a button 20b for acquiring the ID and the content of the assignment associated with the check box, which is checked by being depressed, in the assignment selection screen 20. Further, the reception unit 15a prepares a button 20c for closing the assignment selection screen 20 by being depressed. Further, the reception unit 15a, as illustrated in the example of FIG. 7, prepares a message, which is used for urging the teacher to select the assignment of “Please select an assignment intending for a student to review and depress ‘Transmission’ button.” in the assignment selection screen 20. The reception unit 15a generates the assignment selection screen 20 according to the method described above. Also, the reception unit 15a controls the display unit 12 to display the generated assignment selection screen 20. By doing this, the display unit 12 displays the assignment selection screen 20.

The reception unit 15a determines whether the ID and the content of the assignment associated with the checked check box 20a are received after controlling the display unit 12 to display the assignment selection screen 20. For example, the reception unit 15a determines whether the ID and the content of the assignment associated with the checked check box 20a are acquired as a result of the depression of the button 20b to determine whether the ID and the content of the assignment are received.

When the ID and the content of the assignment are received, the reception unit 15a transmits the received ID and the content of the assignment to the student terminal 3 through the network 5 using an IP address registered in the student DB 14a. Then, as will be described below, a selection result of approval or disapproval about the transmitted content of the assignment, an opinion about the content of the assignment, and a student ID are transmitted from the student terminal 3 to the teacher terminal 2 through the network 5. By doing this, the reception unit 15a may receive the opinion of the student or the selection result of approval or disapproval from the student terminal 3.

Also, the reception unit 15a acquires a limitation time associated with the received ID of the assignment from the assignment DB 14b. Subsequently, the reception unit 15a receives the selection result of approval or disapproval, the opinion about the content of the assignment, and the student ID from the student terminal 3 during a time period until the acquired limitation time elapses after transmitting the ID and the content of the assignment to the student terminal 3. When the selection result of approval or disapproval, the opinion about the content of the assignment, and the student ID are received, the reception unit 15a performs the following process. That is, the reception unit 15a specifies a table 14c_1 in which the received ID of the assignment is registered in the “assignment ID” field among the plurality of tables 14c_1 of the assignment reply DB 14c. Also, the reception unit 15a associates the received student ID, the selection result of approval or disapproval and the content of opinion to be registered in the fields for the “student name”, the “approval/disapproval” and the “opinion content”, respectively.

Also, the reception unit 15a registers each of the coordinates of upper left, lower left, upper right and lower right of the four corners of the area in which the opinion registered in the “opinion content” field is displayed in the fields for the “upper left”, the “lower left”, the “upper right”, and the “lower right” of the specified table 14c_1, respectively. Further, the reception unit 15a generates the coordinates of the four corners of the area in which the opinion registered is displayed such that the received plurality of opinions are displayed in a matrix shape, and registers the generated coordinates in the specified table 14c_1.

By performing the processes described above, the reception unit 15a registers the student ID and the coordinates of the four corners of the area in the specified table 14c_1 together with the selection result of approval or disapproval and the opinion about the content of the assignment received during a time period until the acquired limitation time elapses.

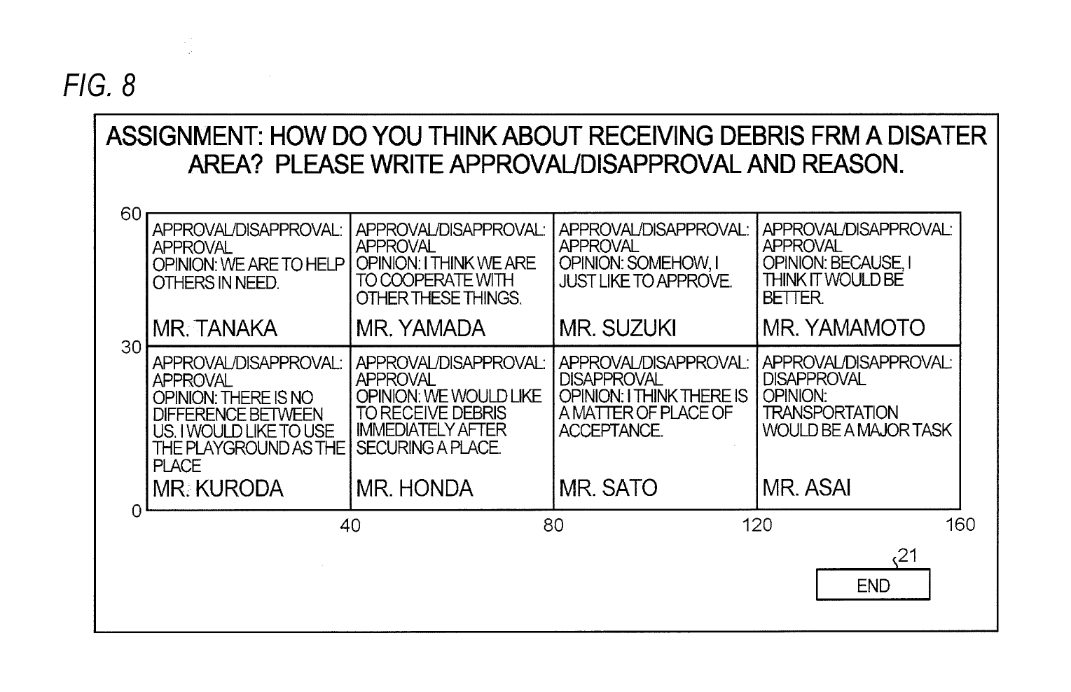

When the limitation time elapses, the reception unit 15a controls the display unit 12 to display the selection result of approval or disapproval and the opinion in a matrix shape. Further, the reception unit 15a controls the projector 4b to display the selection result of approval or disapproval and the opinion on the electronic blackboard 4a in a matrix shape. An example of a process performed by the reception unit 15a to control the display unit 12 and the projector 4b to display the selection result of approval or disapproval and the opinion in a matrix shape will be described. For example, the reception unit 15a acquires registered contents of the “student ID” field, the “approval or disapproval” field, the “opinion content” field and the “opinion display area coordinate” field of all the records of the specified table 14c_1. Also, the reception unit 15a acquires the student name identified by the ID registered in the “student ID” field from the student DB 14a with respect to each of all the records. Also, the reception unit 15a controls the display unit 12 and the projector 4b to display the selection result registered in the “approval/disapproval” field, the content of the opinion registered in the “opinion content” field, and the associated student name registered in the “student name” field to be displayed as follows, with respect to each of all the records. That is, the reception unit 15a controls the display unit 12 and the projector 4b to display the selection result, the content of the opinion, and the student name in the area specified by coordinates of the four corners registered in the “opinion display area coordinate” field. The processes described above are performed by the reception unit 15a and thus, the selection result, the content of opinion and the student name are displayed in the display unit 12 and the electronic blackboard 4a in a matrix shape. FIG. 8 is a view illustrating an example of displayed content when a selection result, a content of opinion and a student name are displayed on a display unit or an electronic blackboard in a matrix shape. For example, when the registered content of the “student ID” field, the “approval/disapproval” field, the “opinion content” field and the “opinion display area coordinate” field of all the records of the table 14c_1 as illustrated in the example of FIG. 5 are acquired, the reception unit 15a performs the following process. That is, the reception unit 15a controls the display unit 12 to display the content as indicated in the example of FIG. 8. Additionally, the reception unit 15a controls the projector 4b to display the content as indicated in the example of FIG. 8 on the electronic blackboard 4a. Here, each number of “40”, “80”, “120” and “160” listed in a horizontal direction indicates the X-coordinate from the origin of coordinates “0” in the example of FIG. 8, and the numbers may not be illustrated in practice. Further, each number of “30” and “60” listed in a vertical direction indicates the Y-coordinate from the origin of coordinates “0” in the example of FIG. 8, and the numbers may not be illustrated in practice. Further, the button 21 is a button for closing the screen, which illustrates the contents in the example of FIG. 8, by being depressed.

The example of FIG. 8 represents a case where the selection result “approval” of the student “Tanaka” is displayed in an area specified by the coordinates of the four corners (e.g., upper left coordinate (0, 60), lower left coordinate (0, 30), upper right coordinate (40, 60), lower right coordinate (40, 30)). Further, the example of FIG. 8 represents a case where the opinion “We are to help someone in need” of the student “Tanaka” is displayed in an area specified by coordinates of the four corners (e.g., upper left coordinate (0, 60), lower left coordinate (0, 30), upper right coordinate (40, 60), lower right coordinate (40, 30)). The same rule applies with opinions of other students.

Further, the reception unit 15a may transmit an instruction to display the received selection result of approval or disapproval and the received opinion in a matrix shape to the student terminal 3. By doing this, the screen containing the content as illustrated in the example of FIG. 8 is displayed.

The reception unit 15a determines whether a mark input in handwriting due to the manipulation of the touch pen or finger by the teacher exists based on the input result from the input unit 11 which may be the touch panel provided on the display unit 12. Further, the reception unit 15a determines whether a mark input in handwriting due to the manipulation of the electronic pen by the teacher exists on the opinion displayed on the electronic blackboard 4a.

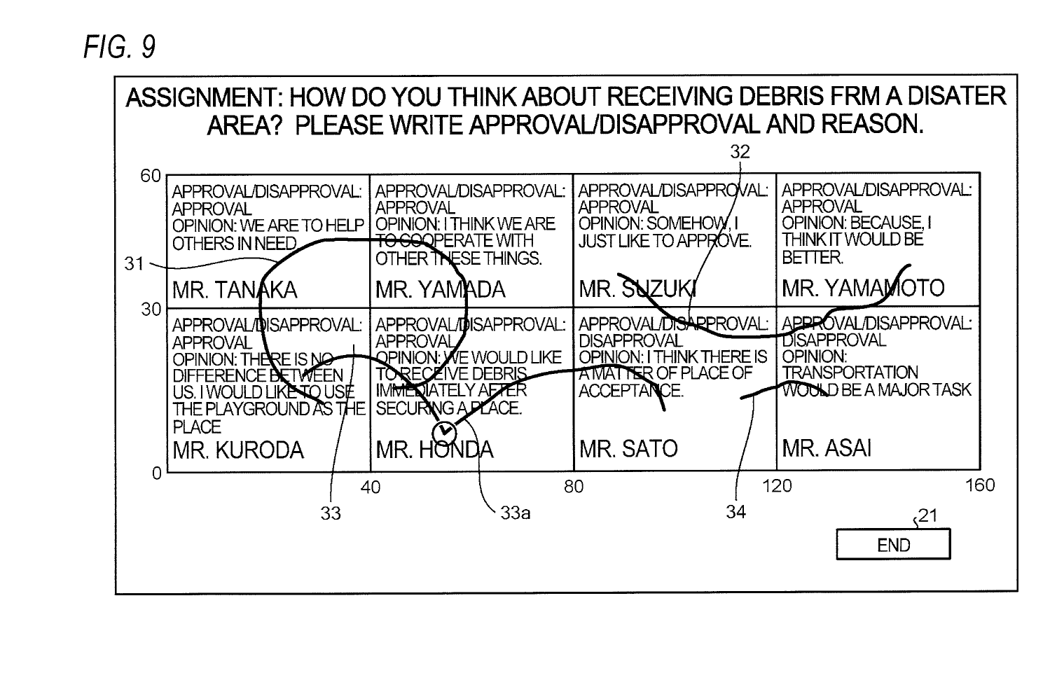

FIG. 9 is a view for explaining a process of determining whether a handwriting input is done. An example of FIG. 9 indicates a case where a mark (symbol) 31 having a shape similar to a circle for interrelating a plurality of opinions replied by the students “Kuroda”, “Tanaka”, “Yamada” and “Honda” who have replied the plurality of persuasive opinions about why they agree, with each other, is input, on the opinions displayed in a matrix shape. Here, the mark having a shape similar to a circle is a mark for interrelating all the opinions displayed on all the areas in which the mark is disposed with each other. As will be described later, four opinions replied by the students “Kuroda”, “Tanaka”, “Yamada” and “Honda” are set to be belonged to the same group by the mark 31. Actually, the start point and the end point of the mark 31 having a shape similar to a circle often exist nearby, and thus, it is determined that the mark 31 having a distance between the start point and the end point of the mark which is shorter than a predetermined distance, is considered to be a mark having a shape similar to a circle in the present embodiment.

Further, the example of FIG. 9 indicates a case where a mark 32 having a line shape for interrelating a plurality of opinions replied by the students “Suzuki” and “Yamamoto”, who have replied the plurality of non-persuasive opinions about why they agree, with each other, is input. Here, the mark having a line shape is a mark for interrelating an opinion displayed on an area in which a start point of the line is located with an opinion displayed on an area in which an end point of the line is located. As will be described in later, an opinion of “Somehow, I just like to” displayed on a start point area and an opinion of “Because, I think it would be better” displayed on an end point area of the mark 32 are set to be belonged to the same group by the mark 32. Actually, the start point of the mark 32 and the end point of the mark 32 having a line shape often exist further away with each other, and thus, it is determined that the mark 32 having a distance between the start point and the end point of the mark which is longer than a predetermined distance, is considered to be a mark having a line shape in the present embodiment.

The example of FIG. 9 indicates a case where a mark 33 having an acute-angled portion 33a in a line for interrelating a plurality of opinions replied by the students “Kuroda”, “Honda” and “Sato”, who have replied opinions about a place for accommodating debris, with each other is input on opinions displayed in a matrix shape. Here, the acute-angled portion indicates a portion of mark which indicates the following characteristics, for example, in a case where a position (X-coordinate, Y-coordinate) of a mark is sampled at predetermined intervals in a direction where the value of X-coordinate increases from origin of coordinates. That is, the acute-angled portion indicates a portion of mark where the value of Y-coordinate changes reversely from increase to decrease and a decrement at predetermined intervals is a predetermined value or more. Further, the acute-angled portion indicates a portion of mark where the value of Y-coordinate changes reversely from decrease to increase and an increment at predetermined intervals is a predetermined value or more, for example, in a case where a position of a mark is sampled at predetermined intervals in an X-axis direction where the value of X-coordinate increases from origin of coordinates. Further, the acute-angled portion indicates a portion of mark where the value of X-coordinate changes from increase to decrease and a decrement at predetermined intervals is a predetermined value or more, for example, in a case where a position of a mark is sampled at predetermined intervals in a Y-axis direction where the value of Y-coordinate increases from origin of coordinates. Further, the acute-angled portion indicates a portion of mark where the value of X-coordinate changes reversely from decrease to increase and an increment at predetermined intervals is a predetermined value or more, for example, in a case where a position of a mark is sampled at predetermined intervals in a Y-axis direction where the value of Y-coordinate increases from origin of coordinates. Further, a point at which the value of X coordinate or Y coordinate in the acute-angled portion is changed from decrease to increase or reversed from increase to decrease is referred to as an increase/decrease change point.

Here, a mark having the acute-angled portion in a line is a mark for interrelating an opinion displayed on an area at which the start point of a line is located, an opinion displayed on an area at which the end point of the line is located, and an opinion displayed on an area at which the acute-angled portion is located with each other. As will be described later, the following opinion is set to be belonged to the same group by the mark 33, in addition to an opinion of “There is no difference between us. I would like to use the playground as the place” displayed on the start point area of the mark 33 and an opinion of “I think there is a matter of place of acceptance” displayed on the end point area of the mark 33. That is, an opinion of “We would like to accommodate debris immediately after securing a place” displayed on an area at which the acute-angled portion is located is set to be belonged to the same group, in addition to the opinion of “There is no difference between us. I would like to use the playground as the place” and the opinion of “I think there is a matter of place of acceptance”. A mark having the shape similar to a circle is not regarded as a target object to be determined as to whether the mark has the acute-angled portion. A mark having coordinates of the line shape of which the start point is away from the end point (e.g., a distance between the start point and the end point is longer than the predetermined distance described above) is regarded as the target object.

Further, the example of FIG. 9 indicates a case where a mark 34 having a line shape for interrelating a plurality of opinions replied by the students “Sato” and “Asai, who have replied an opinion of disapproval, with each other, is input. As will be described later, an opinion of “I think there is a matter of place of acceptance” displayed on the start point area of the mark 34 and an opinion of “Transportation would be a major task” displayed on the end point area of the mark 34 are set to be belonged to the same group by the mark 34.

Here, the example of FIG. 9 indicates that the opinion of the student “Honda” belongs to two groups. Further, the example of FIG. 9 indicates that the opinion of the student “Sato” also belongs to two groups. Further, the example of FIG. 9 indicates that the opinion of the student “Kuroda” also belongs to two groups.

When the mark 31, the mark 32, the mark 33 and the mark 34 as illustrated in the example of FIG. 9 are input, the reception unit 15a determines that a handwriting input is done. When it is determined that the handwriting input is done, the reception unit 15a acquires the coordinate of the start point and the coordinate of the end point of the mark input in handwriting every one stroke. Further, when it is determined that the handwriting input is done, the reception unit 15a acquires progressed coordinates that are coordinate of points between the start point and the end point of the mark along the mark at predetermined intervals.

Also, the reception unit 15a determines whether both the X-coordinate and the Y-coordinate of the value of the acquired progressed coordinates repeat a minute increase or decrease. For example, the reception unit 15a determines whether both the X-coordinate and the Y-coordinate of the value of the acquired progressed coordinates repeat a minute increase or decrease in a range in which a width of amplitude of the X-coordinate and the Y-coordinate does not exceed a predetermined value (a) to determine whether both of the X-coordinate and Y-coordinate repeat a minute increase or decrease.

When it is determined that both of the X-coordinate and the Y-coordinate of the value of the acquired progressed coordinates do not repeat a minute increase or decrease, the reception unit 15a determines whether the coordinate of the start point, the coordinate of the end point and progressed coordinates of the mark input in handwriting are located within an area in which an opinion of a single person is displayed. Here, when it is determined that the coordinate of the start point, the coordinate of the end point and the progressed coordinates of the mark input in handwriting are located within the area in which the opinion of the single person is displayed, the mark is not considered as a mark for interrelating a plurality of opinions with each other. In the meantime, when it is determined that the coordinate of the start point, the coordinate of the end point and the progressed coordinates of the mark input in handwriting are not located within the area in which the opinion of the single person is displayed, the mark is considered as a mark for associating a plurality of opinions with each other.

When it is determined that the coordinate of the start point, the coordinate of the end point and the progressed coordinates of the mark input in handwriting are not located within the area in which the opinion of the single person is displayed, the reception unit 15a performs the following process. That is, the reception unit 15a adds a new record in the handwriting mark coordinate DB 14d and registers a new serial number in a “mark serial number” field of the added record. Also, the reception unit 15a registers the coordinate of the start point of the mark input in handwriting in the “start point coordinate” field of the added record. Further, the reception unit 15a registers the coordinate of end point of the mark input in handwriting in the “end point coordinate” field of the added record. Further, the reception unit 15a registers the progressed coordinates of the mark input in handwriting in the “progressed coordinate” field of the added record. Further, when the mark input in handwriting includes the acute-angled portion, the reception unit 15a registers a coordinate of an increase/decrease change point of the acute-angled portion in the “increase/decrease change point coordinate” field of the added record. As described above, the reception unit 15a registers the coordinate of the start point, the coordinate of the end point, the progressed coordinates and the coordinate of the increase/decrease change point of the received mark in the handwriting mark coordinate DB 14d.

Referring to the description of FIG. 2 again, when the mark is received by the reception unit 15a, the registration unit 15b interrelates a plurality of opinions according to a position and/or a shape of the mark in the display area with each other among a plurality of opinions displayed in a matrix shape and registers the plurality of interrelated opinions as the same group.

One aspect of the registration unit 15b will be described. For example, when the coordinate of the start point, the coordinate of the end point, the progressed coordinates and the coordinate of the increase/decrease change point of the received mark are registered in the handwriting mark coordinate DB 14d by the reception unit 15a, the registration unit 15b performs the following process. That is, the registration unit 15b controls the display unit 12 to display the mark input in handwriting to be overlapped on the opinions displayed in a matrix shape. Further, the registration unit 15b controls the projector 4b to display the mark input in handwriting on the electronic blackboard 4a on the opinions displayed in a matrix shape opinion. By doing this, as illustrated in the example of FIG. 9, a mark such as the mark 31 is displayed to be overlapped on the opinion displayed in a matrix shape. Further, when the opinions are displayed in the student terminal 3 in a matrix shape, the registration unit 15b may transmit an instruction to display the mark input in handwriting to be overlapped to the student terminal 3 through the network 5. By doing this, the mark input in handwriting is displayed to be overlapped on the opinions displayed in a matrix shape in the student terminal 3.

Also, the registration unit 15b determines whether the distance between the coordinate of the start point and the coordinate of the end point of the received mark is shorter than the predetermined distance described above to determine whether the received mark is a mark having a shape similar to a circle.

When it is determined that the distance between the coordinate of the start point and the coordinate of the end point of the received mark is shorter than the predetermined distance, the registration unit 15b performs the following process. That is, the registration unit 15b selects a plurality of areas in which progressed coordinates of the received mark are included among areas specified by the coordinates of four corners registered in the “opinion display area” field of the table 14c_1 in which the received ID of the assignment is registered in the “assignment ID” field. Also, the registration unit 15b specifies a record that the coordinates of four corners in the area are registered among the records of the table 14c_1 with respect to each of the plurality of selected areas and acquires an ID of the student registered in the “student ID” field of the specified record. By doing this, the registration unit 15b acquires the IDs of the plurality of students.

Also, the registration unit 15b registers “1” indicating that the received mark is a mark having a shape similar to a circle in the “type classifying flag” field of the new record added in the handwriting mark coordinate DB 14d by the reception unit 15a.

Also, the registration unit 15b issues a new ID of the group not registered in the “group ID” field of the handwriting mark coordinate DB 14d.

Subsequently, the registration unit 15b specifies a plurality of records that each of the acquired IDs of the plurality of students is registered in the “student ID” field among all the records of the table 14c_1 in which the received ID of the assignment is registered in the “assignment ID” field. Also, the registration unit 15b registers a newly issued ID of the group in the “group ID” field of each of the plurality of records.

Also, the registration unit 15b registers a newly issued ID of the group in the “group ID” field of the new record added in the handwriting mark coordinate DB 14d by the reception unit 15a.

By performing the process described above, the registration unit 15b may set opinions displayed on an area in which a mark having a shape similar to a circle is located to be belonged to the same group.

In the meantime, when it is determined that the distance between the coordinate of the start point and the coordinate of the end point of the received mark is the predetermined distance or more, the registration unit 15b performs the following process. That is, the registration unit 15b determines whether the acute-angled portion exists in the received mark based on the progressed coordinates of the received mark. When it is determined that the acute-angled portion exists in the received mark, the registration unit 15b performs the following process. That is, the registration unit 15b selects an area in which the coordinate of the start point of the received mark is included among areas specified by the coordinates of four corners registered in the “opinion display area” field of the table 14c_1 in which the received ID of the assignment is registered in the “assignment ID” field. Further, the registration unit 15b selects an area in which the coordinate of the end point of the received mark is included among areas specified by the coordinates of four corners registered in the “opinion display area” field of the table 14c_1 in which the received ID of the assignment is registered in the “assignment ID” field. Further, the registration unit 15b selects an area in which the coordinate of the increase/decrease change point or start point of the received mark is included among areas specified by the coordinates of four corners registered in the “opinion display area” field of the table 14c_1 in which the received ID of the assignment is registered in the “assignment ID” field. Also, the registration unit 15b specifies a record that the coordinates of four corners of the area are registered among the records of the table 14c_1 with respect to each of the plurality of selected areas, and acquires an ID of the student registered in the “student ID” field of the specified record. By doing this, the registration unit 15b acquires the IDs of the plurality of students.

Also, the registration unit 15b registers “3” indicating that the received mark is a mark including the acute-angled portion in a line in the “type classifying flag” field of the new record added in the handwriting mark coordinate DB 14d by the reception unit 15a.

Also, the registration unit 15b issues a new ID of a group not registered in the “group ID” field of the handwriting mark coordinate DB 14d.

Subsequently, the registration unit 15b specifies a plurality of records that each of the acquired IDs of the plurality of students is registered in the “student ID” field among all the records of the table 14c_1 in which the received ID of the assignment is registered in the “assignment ID” field. Also, the registration unit 15b registers a newly issued ID of the group in the “group ID” field of each of the plurality of specified records.

Also, the registration unit 15b registers the newly issued ID of the group in the “group ID” field of the new record added in the handwriting mark coordinate DB 14d by the reception unit 15a.

By performing the process described above, the registration unit 15b may set opinions, which are displayed on the areas in which the start point, the end point, and the increase/decrease change point of the mark which includes the acute-angled portion in a line is located, to be belonged to the same grou p.

In the meantime, when it is determined that the acute-angled portion described above does not exist in the received mark, the received mark is a mark having a line shape and thus, the registration unit 15b performs the following process. That is, the registration unit 15b selects an area in which the coordinate of the start point of the received mark is included among areas specified by the coordinates of four corners registered in the “opinion display area” field of the table 14c_1 in which the received ID of the assignment is registered in the “assignment ID” field. Further, the registration unit 15b selects an area in which the coordinate of the end point of the received mark is included among areas specified by the coordinates of four corners registered in the “opinion display area” field of the table 14c_1 in which the received ID of the assignment is registered in the “assignment ID” field. Also, the registration unit 15b specifies a record that the coordinates of four corners in the area are registered among the records of the table 14c_1 with respect to each of the plurality of selected areas (two areas), and acquires an ID of the student registered in the “student ID” field of the specified record. By doing this, the registration unit 15b acquires the IDs of the plurality of students. By doing this, the registration unit 15b acquires a plurality of student IDs.

Also, the registration unit 15b registers “2” indicating that the received mark is a mark having a line shape in the “type classifying flag” field of the new record added in the handwriting mark coordinate DB 14d by the reception unit 15a.

Also, the registration unit 15b issues a new ID of a group not registered in the “group ID” field of the handwriting mark coordinate DB 14d.

Subsequently, the registration unit 15b specifies a plurality of records that each of the acquired IDs of the plurality of students is registered in the “student ID” field among all the records of the table 14c_1 in which the received ID of the assignment is registered in the “assignment ID” field. Also, the registration unit 15b registers a newly issued ID of the group in the “group ID” field of each of the plurality of specified records.

Also, the registration unit 15b registers a newly issued ID of the group in the “group ID” field of the new record added in the handwriting mark coordinate DB 14d by the reception unit 15a.

By performing the process described above, the registration unit 15b may set opinions, which are displayed on an area in which the start point and the end point of the mark having a line shape are located, to be belonged to the same group.

Referring back to the description of FIG. 2, when the mark that the progressed coordinates repeat a minute increase or decrease is received by the reception unit 15a, the release unit 15c releases registration of opinions according to a position of the mark in the display area among the registered opinions.

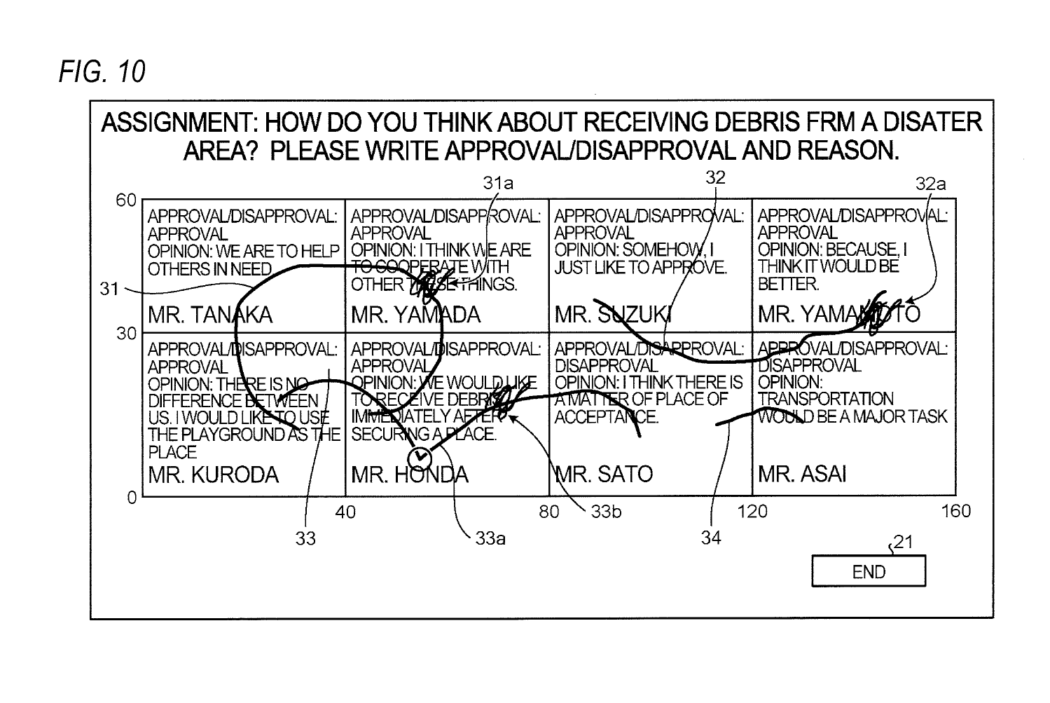

FIG. 10 is a view for explaining a mark which repeats a minute increase or decrease. As illustrated in the example of FIG. 10, the mark 31a which repeats minute increase or decrease is input for releasing an interrelation of the opinion replied by the student “Yamada” among four opinions associated by the mark 31 due to the manipulation of the touch pen or an electronic pen by the teacher, or by the fingers of the teacher. As will be described later, an interrelation of an opinion, which is replied by the student “Yamada” and displayed in an area where the mark 31a is located, among four opinions associated by the mark 31 with other opinions is released due to the input of the mark 31a.

Further, as illustrated in the example of FIG. 10, the mark 32a which repeats minute increase or decrease is input for releasing the interrelation of two opinions interrelated by the mark 32 due to the manipulation of the touch pen or an electronic pen by the teacher, or by manipulation of the fingers of the teacher. As will be described later, an interrelation of the two opinions interrelated by the mark 32 is released due to the input of the mark 32a.

Further, as illustrated in the example of FIG. 10, the mark 33b which repeats minute increase or decrease is input for releasing the interrelation of the opinion replied by the student “Honda” among three opinions interrelated by the mark 33 due to the manipulation of the touch pen or an electronic pen by the teacher, or by manipulation of fingers of a teacher, with other opinions. As will be described later, an interrelation of the opinion, which is replied by the student “Honda” and displayed in an area where the mark 33b is located, among three opinions interrelated by the mark 33 with other opinions is released due to the input of the mark 33b. Further, for description of the present embodiment, the marks 31a, 32a and 33b are illustrated in FIG. 10, but may not be illustrated in practice.

One aspect of the release unit 15c will be described. When it is determined by the reception unit 15a that both the value of X-coordinate and the value of Y-coordinate of the progressed coordinates repeat a minute increase or decrease, the release unit 15c performs the following process. That is, the release unit 15c selects an area in which the coordinate of the start point of the received mark is included among areas specified by the coordinates of four corners registered in the “opinion display area” field of the table 14c_1 in which the received ID of the assignment is registered in the “assignment ID” field. Also, the registration unit 15b specifies a record that the coordinates of four corners in the selected area are registered among the records of the table 14c_1 and acquires an ID of the student registered in the “student ID” field of the specified record.

Also, the release unit 15c refers to the “group ID” field of the specified record to determine whether the ID of the group is registered in the “group ID” field. When it is determined that the ID of the group is registered, the release unit 15c specifies a record that the ID of the group determined as being registered corresponds to the “group ID” among all the records of the handwriting mark coordinate DB 14d. Also, the release unit 15c acquires the value of the flag registered in the “type classifying flag” field of the specified record.

Also, the release unit 15c determines whether the acquired value of the flag is “1”. When it is determined that the acquired value of the flag is “1”, the release unit 15c deletes the ID of the group registered in the “group ID” field of the specified record in the table 14c_1 in which the received ID of the assignment is registered in the “assignment ID” field. By doing this, the interrelation of the opinion displayed on an area which includes the coordinate of the start point of the received mark and other opinions is released.

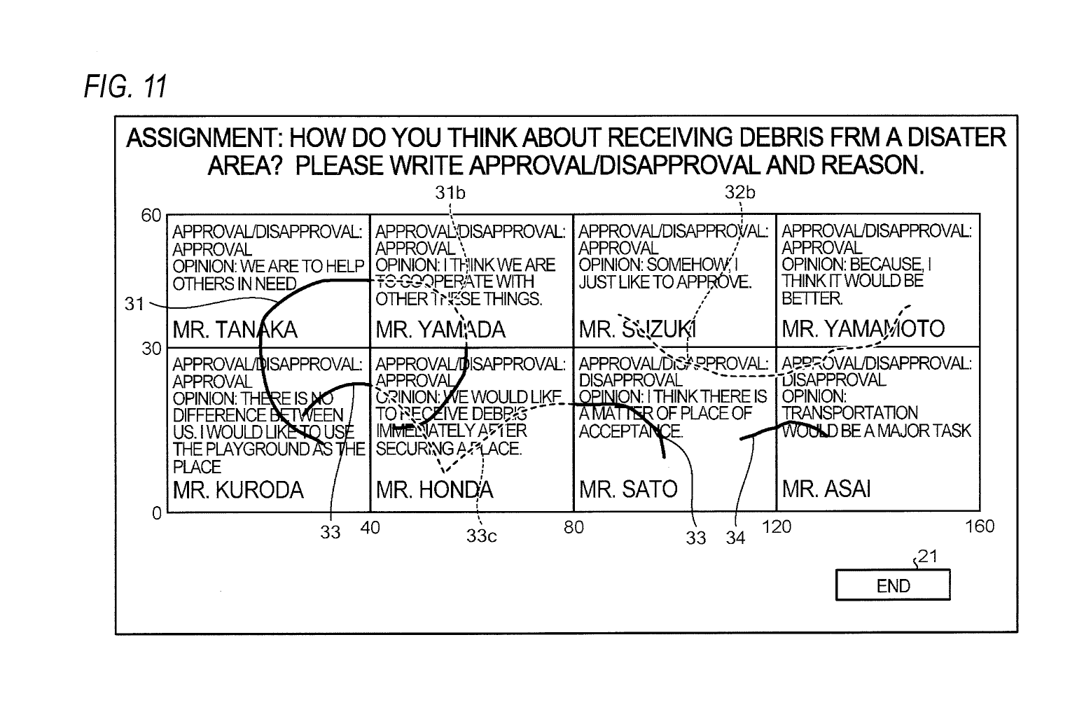

Subsequently, the release unit 15c acquires progressed coordinates corresponding to a deleted ID from the handwriting mark coordinate DB 14d. Also, the release unit 15c acquires a group of coordinates included in a selected area among the acquired progressed coordinates. Subsequently, the release unit 15c changes a portion of a line segment, which corresponds to the acquired group of coordinates among the line segment of the mark displayed to be overlapped on the opinion displayed in a matrix shape, into a broken line. FIG. 11 is a view for explaining a process of changing a line segment of mark into a broken line. As illustrated in an example of FIG. 10, when the mark 31a which repeats a minute increase or decrease is input, the release unit 15c releases the interrelation of the opinion displayed in an area in which the mark 31a is located with other opinions and changes a line segment 31b on the area in which the mark 31a is located into a broken line, as illustrated in FIG. 11.

Also, the release unit 15c registers the acquired group of coordinates in the “erasure coordinate” field of the specified record of the handwriting mark coordinate DB 14d.

By performing the process described above, the release unit 15c releases the interrelation of the opinion displayed in an area in which the mark which repeats the minute increase or decrease is located with other opinions among a plurality of opinions that are set to be belonged to the same group.

In the meantime, when it is determined that the acquired value of the flag is not “1”, the release unit 15c determines whether the acquired value of the flag is “3”. When it is determined that the acquired value of the flag is “3”, the release unit 15c specifies a record that the ID of the group determined as being registered all the records of the handwriting mark coordinate DB 14d corresponds to the “group ID”. Also, the release unit 15c acquires the coordinate of the start point registered in the “start point coordinate” field of the specified record. Further, the release unit 15c acquires the coordinate of the end point registered in the “end point coordinate” field of the specified record. Further, the release unit 15c acquires the progressed coordinates registered in the “progressed coordinate” field of the specified record. Further, the release unit 15c acquires the coordinate of the increase/decrease change point registered in the “increase/decrease change point” field of the specified record.

Also, the release unit 15c determines whether the acquired coordinate of the start point or the acquired coordinate of the end point is included in an area in which the coordinate of the start point of the received mark is included. When it is determined that the acquired coordinate of the start point or the acquired coordinate of the end point is included in an area in which the coordinate of the start point of the received mark is included, the release unit 15c deletes the ID of the group registered in “group ID” field of the specified record in the table 14c_1 in which the received ID of the assignment is registered in the “assignment ID” field. By doing this, the interrelation of the opinion displayed in an area in which the coordinate of the start point of the received mark with other opinions is released.

Also, the release unit 15c acquires a group of coordinates that falls within a range from the acquired coordinate of the start point or the acquired coordinate of the end point included in an area, in which the coordinate of the start point of the received mark is included, to the nearest coordinate of the increase/decrease change point.

Subsequently, the release unit 15c changes a portion of the line segment, which corresponds to the acquired group of coordinates among the line segment of the mark displayed to be overlapped on the opinion displayed in a matrix shape, into a broken line.

Also, the release unit 15c registers the acquired group of coordinates in the “erasure coordinate” field of the specified record of the handwriting mark coordinate DB 14d.

By performing the process described above, the release unit 15c performs the following process. That is, the release unit 15c release the interrelation of opinions displayed in an area ranging from the coordinate of the start point or the end point of a mark, having a shape which includes the acute-angled portion in a line, to the nearest increase/decrease change point among a plurality of opinions set to be belonged to the same group by the mark with other opinions.

In the meantime, when it is determined that the acquired coordinate of the start point and the acquired coordinate of the end point are not included in the area in which the coordinate of the start point of the received mark is included, the release unit 15c determines whether the coordinate of the acquired increase/decrease change point is included in the area in which the coordinate of the start point of the received mark is included. When it is determined that the coordinate of the acquired increase/decrease change point is included in the area in which the coordinate of the start point of the received mark is included, the release unit 15c deletes the ID of the group registered in “group ID” field of the specified record in the table 14c_1 in which the received ID of the assignment is registered in the “assignment ID” field. By doing this, the interrelation of the opinion displayed in an area in which the coordinate of the start point of the received mark and other opinions with other opinions is released.

Also, the release unit 15c acquires the group of coordinates included in the selected area among the acquired progressed coordinates. Subsequently, the release unit 15c changes a portion of the line segment, which corresponds to the acquired group of coordinates among the line segment of the mark displayed to be overlapped on the opinion displayed in a matrix shape, into a broken line. As illustrated in the example of FIG. 10, when the mark 33b which repeats a minute increase or decrease is input, the release unit 15c releases the interrelation of the opinion displayed in an area in which the mark 33b is located with other opinions and changes the line segment 33c in the area in which the mark 33b is located into a broken line.

Also, the release unit 15c registers the acquired group of coordinates in the “erasure coordinate” field of the specified record of the handwriting mark coordinate DB 14d.

By performing the process described above, the release unit 15c performs the following process. That is, the release unit 15c releases the interrelation of opinions displayed in the area in which the increase/decrease change point of the mark is located among a plurality of opinions set to be belonged to the same group by the mark including the acute-angled portion in a line.

In the meantime, when it is determined that the acquired value of the flag is not “3”, the release unit 15c determines whether the acquired value of the flag is “2”. When it is determined that the acquired value of the flag is “2”, the release unit 15c performs the following process. That is, the release unit 15c deletes all the IDs of group, that are determined as being registered, among the IDs of group registered in “group ID” field of the specified record in the table 14c_1 in which the received ID of the assignment is registered in the “assignment ID” field. By doing this, the interrelation of the opinion displayed in the area in which the coordinate of the start point and the coordinate of the end point of the received mark with other opinions is released.

Also, the release unit 15c specifies a record that the ID of the group determined as being registered among all the records of the handwriting mark coordinate DB 14d is registered in the “group ID” field. Also, the release unit 15c acquires a group of progressed coordinates registered in the “progressed coordinate” field of the specified record.

Subsequently, the release unit 15c changes a portion of the line segment, which corresponds to the acquired group of coordinates among the line segment of the mark displayed to be overlapped on the opinion displayed in a matrix shape, into a broken line. As illustrated in the example of FIG. 10, when the mark 32a which repeats a minute increase or decrease is input, the release unit 15c releases the interrelation of the opinion displayed in each area in which the coordinate of the start point and the coordinate of the end point of the mark 32a are located and changes the line segment 32b into a broken line, as illustrated in FIG. 11.

Also, the release unit 15c registers the acquired group of coordinates in the “erasure coordinate” field of the specified record of the handwriting mark coordinate DB 14d.

By performing the process described above, the release unit 15c performs the following process. That is, the release unit 15c releases the interrelation of opinions displayed in the area in which the start point and the end point of a mark having a line shape are located among a plurality of opinions set to be belonged to the same group by the mark.

Referring back to the description of FIG. 2, when any opinion included in a plurality of opinions is designated, the display control unit 15d controls the display device 12 to display other opinions included in a group of opinions that belong to a group together with the designated opinion in a case where the designated opinion belongs to the group. Further, when any opinion included in a plurality of opinions is designated, the display control unit 15d controls the projector 4b to display other opinions included in a group of opinions that belong to a group on the electronic blackboard 4a together with the designated opinion, in a case where the designated opinion belongs to the group. Further, when any opinion included in a plurality of opinions is designated, the display control unit 15d may transmit instruction to display other opinions included in a group of opinions that belong to a group together with the designated opinion to the student terminal 3, in a case where the designated opinion belongs to the group. By doing this, other opinions that belong to the group to which the designated opinion belongs are displayed in the student terminal 3, together with the designated opinion.

One aspect of the display control unit 15d will be described. When it is determined by the reception unit 15a that a handwriting input is done neither by the manipulation of the touch pen or finger of the teacher nor by the manipulation of an electronic pen of the teacher, the display control unit 15d performs the following process. That is, the display control unit 15d determines whether any opinion is selected among a plurality of opinions displayed in a matrix shape due to the depression of the input unit 11 that is a touch panel by the teacher. When it is determined that any opinion is selected, the display control unit 15d specifies a record, using the selected coordinate and the opinion display area coordinate, among all the records of the table 14c_1 in which the received ID of the assignment is registered in the “assignment ID” field. Also, the display control unit 15d acquires all the IDs of group registered in the “group ID” field of the specified record.

Also, the display control unit 15d specifies all the records in which (that) the acquired ID of the group is registered in the “group ID” field among all the records of the table 14c_1 in which the received ID of the assignment is registered in the “assignment ID” field. Subsequently, the display control unit 15d acquires the ID of the student registered in the “student ID” field, a selection result of approval or disapproval registered in the “approval/disapproval” field, the content of opinion registered in the “opinion content” field of each of all the specified records.

Also, the display control unit 15d determines whether a time during which the input unit 11 that is a touch panel is depressed by the teacher is shorter than the predetermined time T. When it is determined that the time during which the input unit 11 that is a touch panel is depressed by the teacher is shorter than the predetermined time T, the display control unit 15d controls the display unit 12 to display the opinion and the selection result of approval or disapproval selected by the teacher in an enlarged scale. Further, the display control unit 15d controls the projector 4b to display the opinion and the selection result of approval or disapproval selected by the teacher on the electronic blackboard 4a in an enlarged scale.

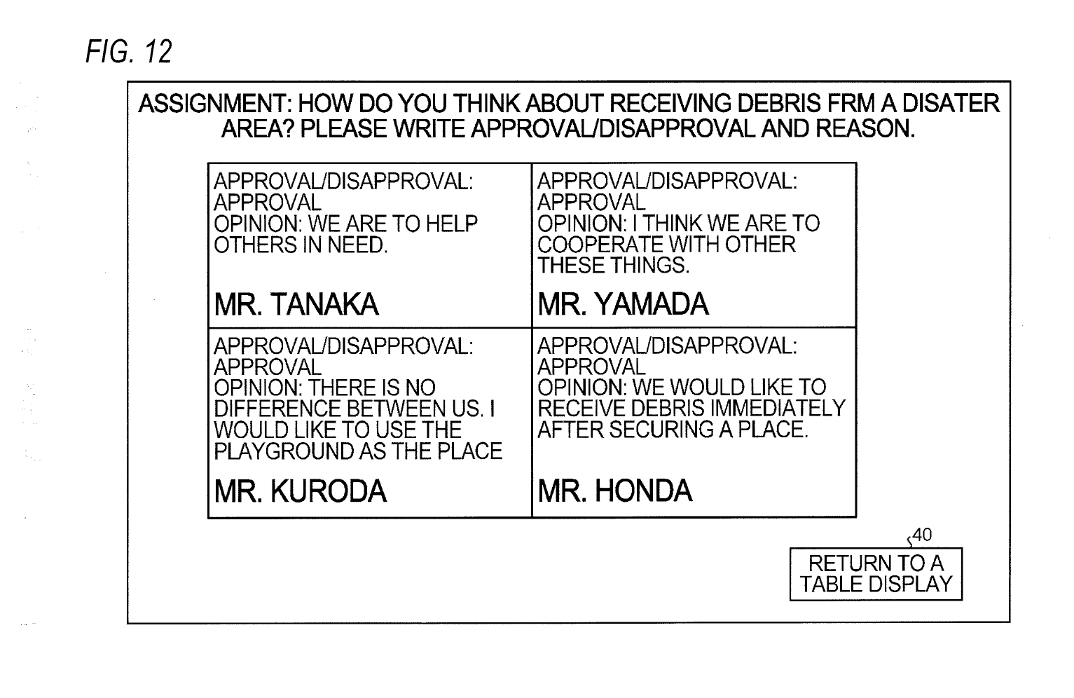

A description will be made on a content of a process in which the display control unit 15d controls the display unit 12 or the projector 4b to display the opinion and the selection result of approval or disapproval selected in an enlarged scale. The display control unit 15d acquires the student name identified by the acquired ID of the student from the student DB 14a. Also, the display control unit 15d controls the display unit 12 and the projector 4b to display the acquired selection result, the acquired content of opinion and the acquired student name to be displayed as in the following description. That is, the display control unit 15d controls the display unit 12 and the projector 4b to display the selection result, the content of opinion and the student name in an enlarged scale. By doing this, the selection result, the content of opinion and the student name are displayed in an enlarged scale in the display unit 12 and the electronic blackboard 4a. FIG. 12 to FIG. 15 are views illustrating examples of a displayed content when the selection result, the content of opinion and the student name are displayed on the display unit or the electronic blackboard in an enlarged scale. For example, in an example illustrated in FIG. 9, when the touch panel on an area in which the opinion of the student “Tanaka” is displayed is depressed for a time period which is shorter than the predetermined time T by the teacher, the display control unit 15d performs the following process. That is, the display control unit 15d, as illustrated in the example of FIG. 12, controls the display unit 12 and the electronic blackboard 4a to display the opinions of the students “Kuroda”, “Yamada” and “Honda” that belong to the same group to which the student “Tanaka” belongs together, in addition to the opinion of the student “Tanaka”. Further, “Return to a table display” button 40 is a button for returning to a screen, for example, a screen of the displayed content as illustrated in the example of FIG. 9, before the content is displayed in an enlarged scale due to the depression of the button.

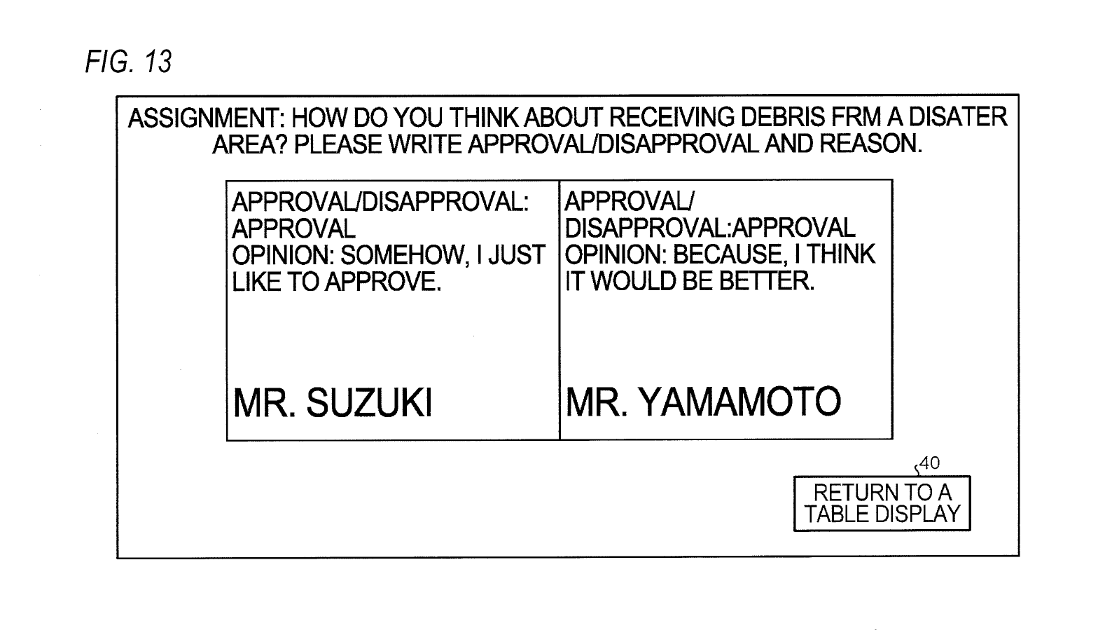

Further, in an example illustrated in FIG. 9, when the touch panel on an area in which the opinion of the student “Suzuki” is displayed is depressed for a time period which is shorter than the predetermined time T by the teacher, the display control unit 15d performs the following process. That is, the display control unit 15d, as illustrated in the example of FIG. 13, controls the display unit 12 and the electronic blackboard 4a to display the opinion of the student “Yamamoto” that belongs to the same group to which the student “Suzuki” belongs together, in addition to the opinion of the student “Suzuki”.

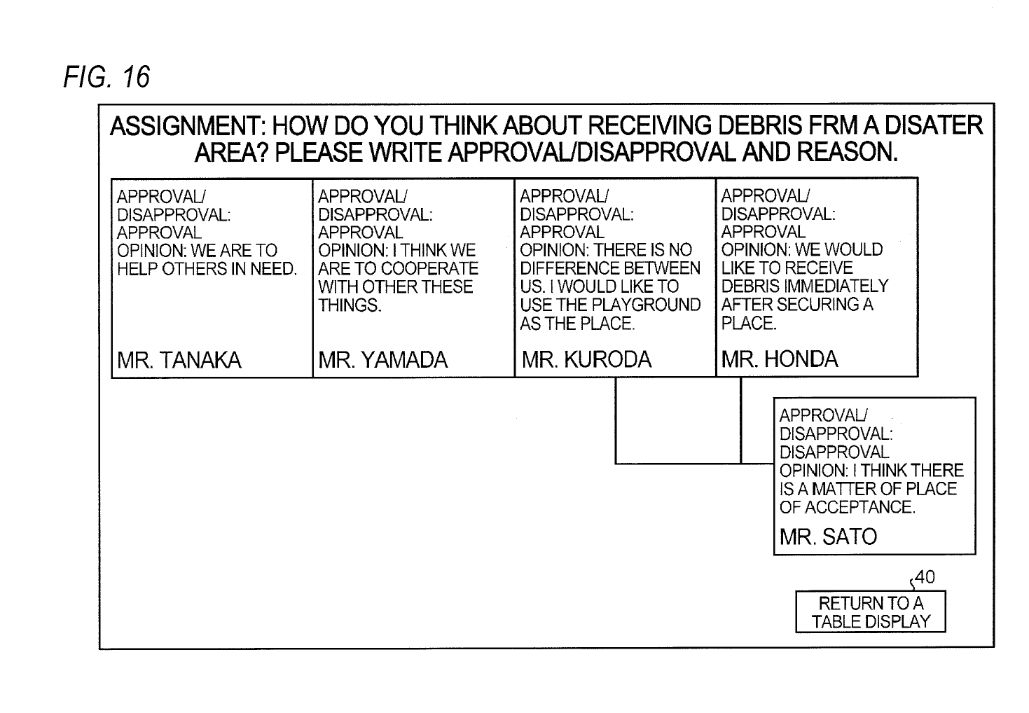

In the meantime, when it is determined that the time during which the input unit 11 that is a touch panel is depressed by the teacher is the predetermined time T or more, the display control unit 15d performs the following process. That is, the display control unit 15d specifies a record that the selected coordinate includes a student ID included in the opinion display area coordinate from all the records of the table 14c_1 in which the received ID of the assignment is registered in the “assignment ID” field. Also, the display control unit 15d acquires other record which includes the ID of the group registered in “group ID” field of the specified record. And, the display control unit 15d determines whether a group ID which is different from the group ID associated with the specified student ID is included in other record, and when it is determined that a different group ID is included in other records, the display control unit 15d acquires the ID of the group. Also, the display control unit 15d specifies all the records in which the newly acquired ID of the group is registered in “group ID” field from all the records of the table 14c_1 in which the received ID of the assignment is registered in the “assignment ID” field. Subsequently, the display control unit 15d acquires the ID of the student registered in the “student ID” field, a selection result of approval or disapproval registered in the “approval/disapproval” field, the content of opinion registered in the “opinion content” field of each of all the specified records. The display control unit 15d acquires the student name identified by the acquired ID of the student from the student DB 14a. Also, the display control unit 15d controls the display unit 12 and the projector 4b to display the acquired selection result, the acquired content of opinion and the acquired student name to be displayed as in the following description. That is, the display control unit 15d controls the display unit 12 and the projector 4b to display the selection result, the content of opinion and the student name in an enlarged scale. By doing this, opinions that belong to a different group to which a different opinion belongs are displayed in an enlarged scale in the display unit 12 and the electronic blackboard 4a, in addition to other opinions that belong to a group to which the selected opinion belongs. FIG. 16 is a view illustrating an example of a displayed content when a selection result, a content of opinion and a student name are displayed on the display unit or the electronic blackboard in an enlarged scale. For example, in the example illustrated in FIG. 9, when the touch panel on the area in which the opinion of the student “Tanaka” is displayed is depressed for a time period which is equal to or less than the predetermined time T by the teacher, the display control unit 15d performs the following process. That is, the display control unit 15d, as illustrated in the example of FIG. 16, controls the display unit 12 and the electronic blackboard 4a to display the following opinions together, in addition to the opinion of the student “Tanaka” opinion, the opinions of the students “Kuroda”, “Yamada” and “Honda” that belong to the same group to which the opinion of the student “Tanaka”. That is, the display control unit 15d controls the display unit 12 and the electronic blackboard 4a to display the opinion of the student “Sato” who belongs to another group to which the opinion of the student “Honda” or the student “Kuroda” belongs.

Also, when the “Return to a table display” button 40 is depressed, the display control unit 15d generates a screen before being transferred to an enlarged screen using registered contents of the assignment reply DB 14c and the handwriting mark coordinate DB 14d, and controls the display unit 12 to display the generated screen. Next, the display control unit 15d controls the projector 4b to display the generated screen on the electronic blackboard 4a. Further, the display control unit 15d may transmit an instruction to display the generated screen to the student terminal 3.

Referring back to the description of FIG. 2, the determination unit 15e determines whether a request to end is input from the input unit 11 due to the manipulation of the input unit 11 by the teacher. When it is determined that the request to end is input, the determination unit 15e ends the display process.

The control unit 15 may be a circuit such as the ASIC (Application Specific Integrated Circuit), FPGA (Field Programmable Gate Array), CPU (Central Processing Unit) or MPU (Micro Processing Unit).

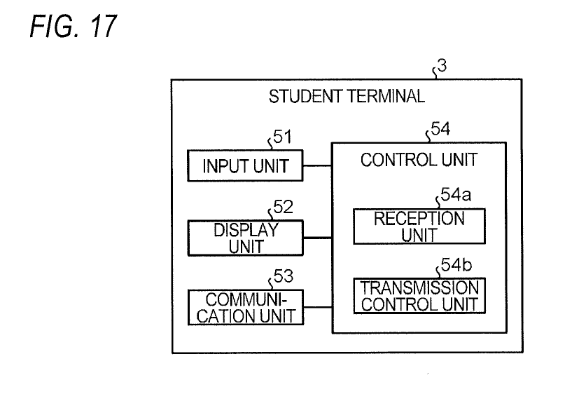

Referring to the description of FIG. 1, the student terminal 3 may be a variety of terminals including, for example, a mobile terminal, such as a slate terminal, in which a handwriting input is allowed. The student terminal 3 is used by a student who attends in class. FIG. 17 is a view illustrating an exemplary functional configuration of a student terminal. As illustrated in an example of FIG. 17, the student terminal 3 includes an input unit 51, a display unit 52, a communication unit 53 and a control unit 54.

The input unit 51 inputs various information to the control unit 54. For example, the input unit 51 may be a touch panel provided on the display unit 52, receives the manipulation of the touch pen or finger used by a student who attends in a class, and inputs the received manipulation to the control unit 54.

The display unit 52 displays various information. For example, the display unit 52 displays a reply screen to be described below by the control of the reception unit 54a. An example of the display unit 52 may include a liquid crystal display.

The communication unit 53 may be a communication interface for allowing the student terminal 3 and the teacher terminal 2 to communicate with each other.

The control unit 54 includes an internal memory for storing a program defining various processing sequences or a control data, and executes various processes by the program and the control data. As illustrated in FIG. 17, the control unit 54 includes a reception unit 54a and a transmission control unit 54b.

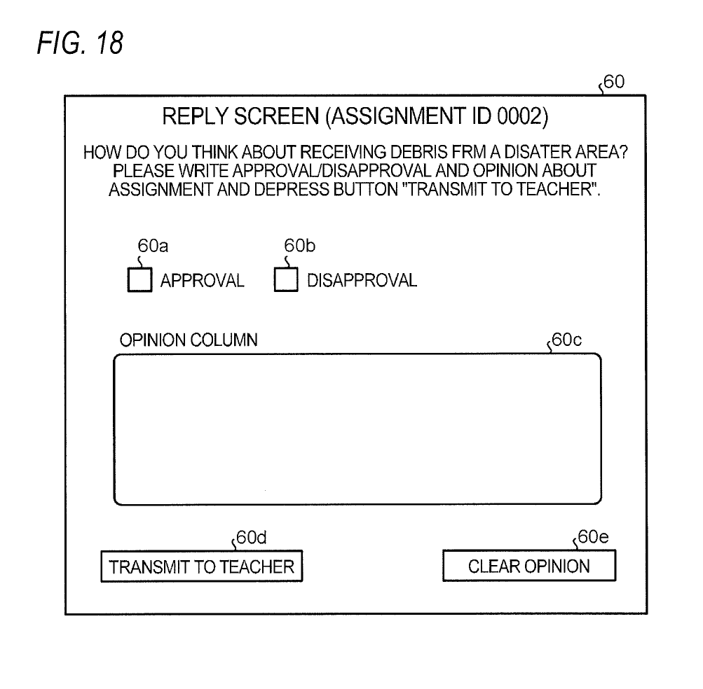

FIG. 18 is a view illustrating an exemplary reply screen. When the ID and the content of the assignment transmitted from the teacher terminal 2 are received, the reception unit 54a generates a reply screen 60 as illustrated in the example of FIG. 18 using the ID and the content of the assignment. When the student has an opinion of approval for an assignment, the check box 60a is checked due to the manipulation of the input unit 51 by the student. Further, when the student has an opinion of disapproval for the assignment, the check box 60b is checked due to the manipulation of the input unit 51 by the student. The opinion for the assignment is input to a text box 60c due to the manipulation of the input unit 51 by the student. The button 60d is a button for transmitting check results of the check boxes 60a and 60b and the opinion input to the text box 60c to the teacher terminal 2. When the button 60d is depressed, the check results of the check boxes 60a and 60b and the opinion input to the text box 60c are transmitted to the teacher terminal 2 through the communication unit 53 by a transmission control unit 54b to be described below. The button 60e is a button for clearing the check results of the check boxes 60a and 60b and the opinion input to the text box 60c. When the button 60e is depressed, the check results of the check boxes 60a and 60b and the opinion input to the text box 60c are cleared.

When the button 60d is depressed due to the manipulation of the input unit 51 by the student, the transmission control unit 54b transmits the check results of the check boxes 60a and 60b and the opinion input to the text box 60c to the teacher terminal 2 through the communication unit 53.

The control unit 54 is a circuit such as the ASIC, FPGA, CPU or MPU.

[Flow of Process]

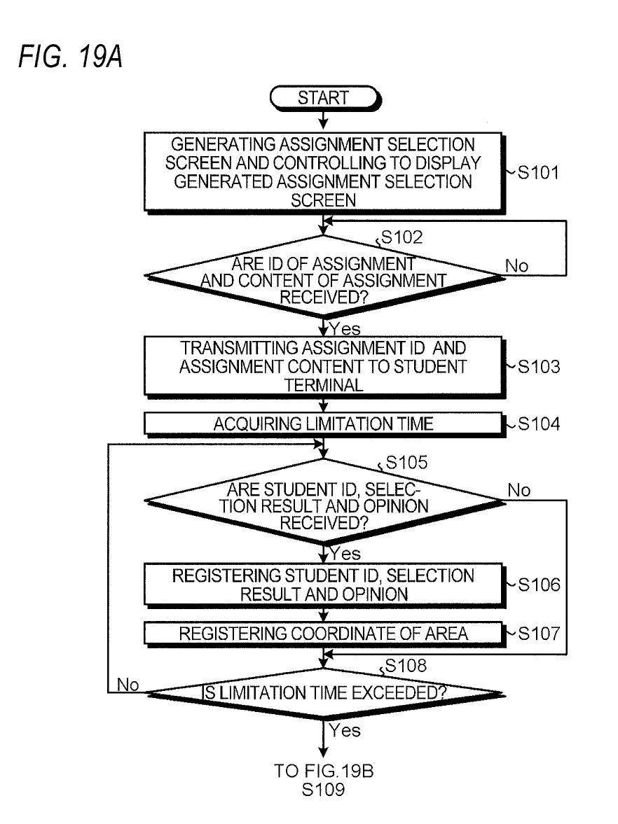

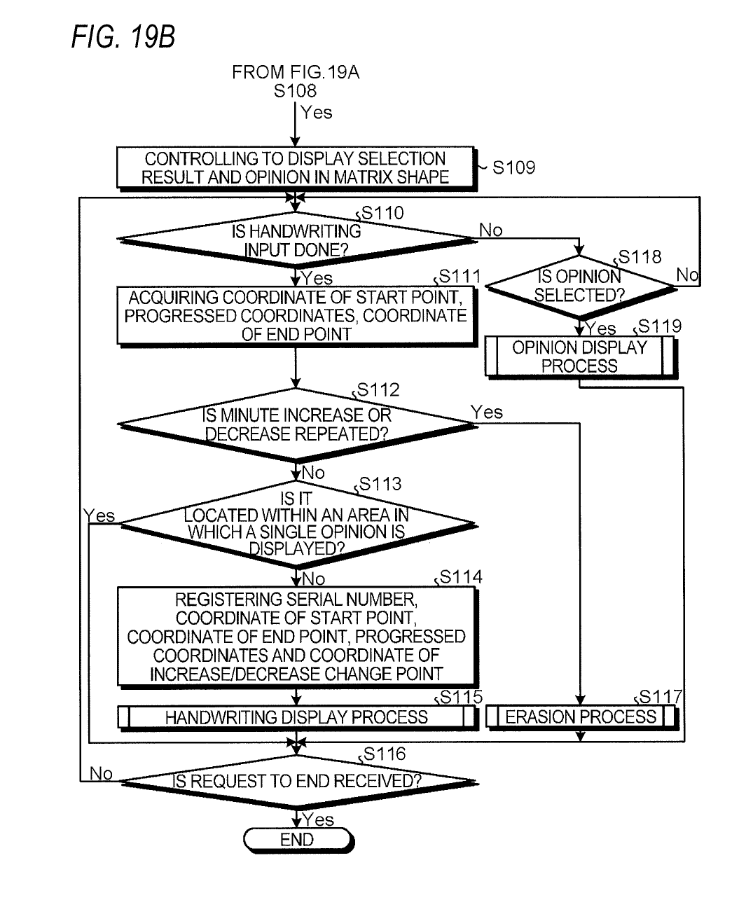

Next, a flow of process executed by the teacher terminal 2 according to the present embodiment will be described. FIG. 19A and FIG. 19B are flowcharts illustrating a procedural sequence of a display process according to the embodiment. For example, when an instruction to execute the display process is input to the control unit 15 from the input unit 11, the display process according to the embodiment is executed by the control unit 15.

As illustrated in FIG. 19A and FIG. 19B, the reception unit 15a generates an assignment selection screen using the assignment DB 14b and controls the display unit 12 to display the generated assignment selection screen (S101). The reception unit 15a determines whether the ID and the content of the assignment associated with the check box 20a checked are received (S102). When it is determined that the ID and the content of the assignment are not received (“NO” at step S102), the reception unit 15a performs the process of step S102 again.

When it is determined that the ID and the content of the assignment are received (“YES” at step S102), the reception unit 15a transmits the received ID and the content of the assignment to the student terminal 3 through the network 5 using an IP address registered in the student DB 14a (S103).

Also, the reception unit 15a acquires the limitation time associated with the received ID of the assignment from the assignment DB 14b (S104). Subsequently, the reception unit 15a determines whether the student ID, the selection result of approval or disapproval and the opinion about the content of assignment are received from the student terminal 3 (S105). When it is determined that the student ID, the selection result of approval or disapproval and the opinion about the content of assignment are not received (“NO” at step S105), the reception unit 15a proceeds to step S108 to be described below. In the meantime, when it is determined that the student ID, the selection result of approval or disapproval and the opinion about the content of assignment are received (“YES” at step S105), the reception unit 15a performs the following process. That is, the reception unit 15a specifies the table 14c_1 in which the received ID of the assignment is registered in the “assignment ID” field among a plurality of the tables 14c_1 of the assignment reply DB 14c. Also, the reception unit 15a associates the received selection result of approval or disapproval with the opinion about the content of assignment, and associates the selection result and the opinion with the student ID of the specified table 14c_1 to register the selection result and the opinion in the “approval/disapproval” field and the “opinion content” field (S106).

Here, a student ID and an opinion display area coordinate may be recorded in the assignment reply DB 14c in advance. Specifically, a display area is automatically calculated using an ID included in the student ID and the number of students, and the coordinates of the display area are prepared, such that the student ID and the opinion display area coordinate are recorded in the assignment reply DB 14c. When the student ID and the opinion display area coordinate are recorded in the assignment reply DB 14c in advance, the reception unit 15a proceeds to step S108 without performing the process of step S107. In the meantime, when the student ID and the opinion display area coordinate are not recorded in the assignment reply DB 14c in advance, the reception unit 15a registers each of coordinates (each of upper left coordinate, lower left coordinate, upper right coordinate, lower right coordinate) of the four corners of the area, in which the opinion registered in the “opinion content” field is displayed in the “upper left” field, the “lower left” field, the “upper right” field, and the “lower right” field of the specified table 14c_1, respectively (S107).

Also, the reception unit 15a determines whether a limitation time is exceeded (S108). When it is determined that the limitation time is not exceeded (“NO” at step S108), the reception unit 15a goes back to step S105. When it is determined that the limitation time is exceeded (“YES” at step S108), the reception unit 15a controls the display unit 12 to display the received selection result of approval or disapproval and the opinion in a matrix shape. Further, the reception unit 15a controls the projector 4b to display the received selection result of approval or disapproval and the opinion on the electronic blackboard 4a in a matrix shape. Further, the reception unit 15a may transmit an instruction to display the received selection results of approval or disapproval and the opinion in a matrix shape to the student terminal 3 (S109).

Also, the reception unit 15a determines whether a handwriting input is done due to the manipulation of the touch pen by the teacher, based on the result input from the input unit 11 which is the touch panel and provided on the display unit 12. Further, the reception unit 15a may determine whether a handwriting input is done on the opinion displayed on the electronic blackboard 4a due to the manipulation of the electronic pen by the teacher (S110).

When it is determined that the handwriting input is done (“YES” at step S110), the reception unit 15a acquires the coordinate of the start point and the coordinate of the end point of a mark input in handwriting every one stroke. Further, the reception unit 15a acquires progressed coordinates that are coordinates of points between the start point and the end point of the mark along the mark at predetermined intervals (S111).

Also, the reception unit 15a determines whether both the X-coordinate and the Y-coordinate of the value of the acquired progressed coordinates repeat a minute increase or decrease (S112).

When it is determined that both the X-coordinate and the Y-coordinate of the value of the acquired progressed coordinates do not repeat a minute increase or decrease (“NO” at step S112), the reception unit 15a determines whether a coordinate of the start point, a coordinate of the end point and progressed coordinates of the mark input in handwriting are located within an area in which an opinion of a single person is displayed (S113). When it is determined that the coordinate of the start point, the coordinate of the end point and the progressed coordinates of the mark input in handwriting are located within the area in which the opinion of the single person is displayed (“YES” at step S113), the reception unit 15a proceeds to step S116 to be described below.

In the meantime, when it is determined that the coordinate of the start point, the coordinate of the end point and the progressed coordinates of the mark input in handwriting are not located within the area in which the opinion of the single person is displayed (“NO” at step S113), the reception unit 15a adds a new record in the handwriting mark coordinate DB 14d and registers a new serial number in the “mark serial number” field of the added record. Also, the reception unit 15a registers the coordinate of the start point of the mark input in handwriting in the “start point coordinate” field of the added record. Further, the reception unit 15a registers the coordinate of end point of the mark input in handwriting in the “end point coordinate” field of the added record. Further, the reception unit 15a registers the progressed coordinates of the mark input in handwriting in the “progressed coordinate” field of the added record. Further, the reception unit 15a determines whether the mark input in handwriting includes the acute-angled portion using the coordinate. And, when the mark input in handwriting includes the acute-angled portion, the reception unit 15a registers a coordinate of an increase/decrease change point of the acute-angled portion in the “increase/decrease change point coordinate” field of the added record. As described above, the reception unit 15a registers the coordinate of the start point, the coordinate of the end point, the progressed coordinates and the coordinate of the increase/decrease change point of the received mark in the handwriting mark coordinate DB 14d (S114).

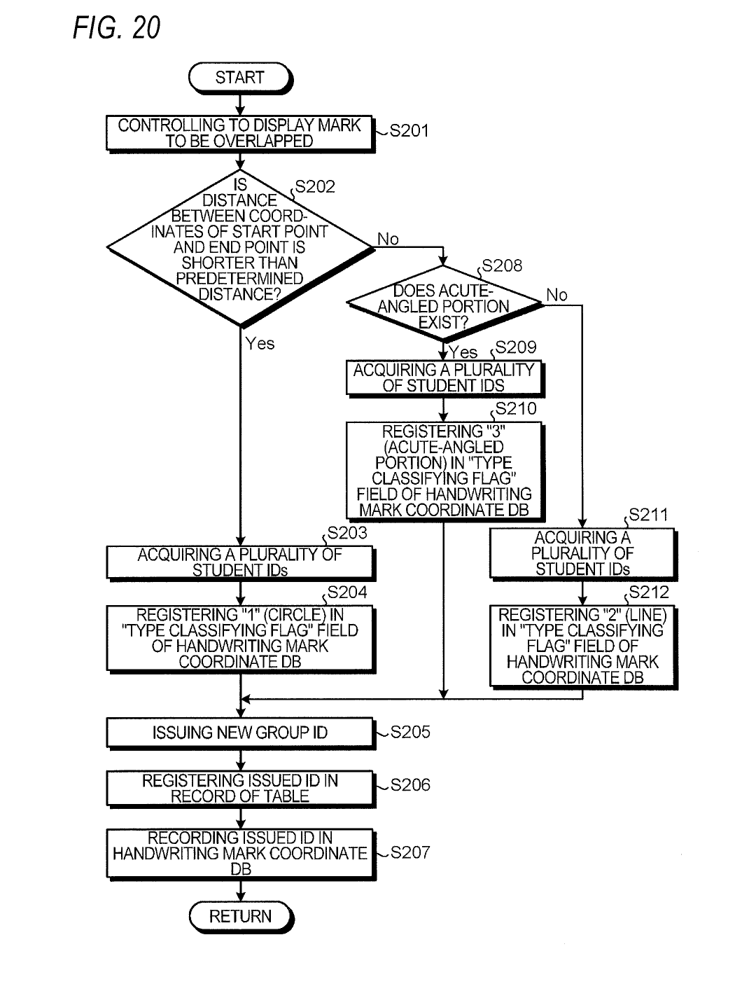

Also, the registration unit 15b performs a handwriting display process (S115). FIG. 20 is a flowchart illustrating a procedural sequence of a handwriting display process according to an embodiment. As illustrated in FIG. 20, the registration unit 15b controls the display unit 12 to display the mark input in handwriting to be overlapped on the opinion displayed in a matrix shape. Further, the registration unit 15b controls the projector 4b to display the mark input in handwriting to be overlapped on the opinion displayed on the projector 4b in a matrix shape. Further, when the opinion is displayed in the student terminal 3 in a matrix shape, the registration unit 15b may transmit an instruction to display the mark input in handwriting to be overlapped to the student terminal 3 through the network 5 (S201).

Also, the registration unit 15b determines whether the distance between the coordinate of the start point and the end point of the received mark is shorter than the predetermined distance to determine whether the received mark is a mark having a shape similar to a circle (S202).

When it is determined that the distance between the coordinate of the start point and the end point of the received mark is shorter than the predetermined distance (“YES” at step S202), the registration unit 15b performs the following process. That is, the registration unit 15b selects a plurality of areas in which progressed coordinates of the received mark are included among areas specified by the coordinates of four corners registered in the “opinion display area” field of the table 14c_1 in which the received ID of the assignment is registered in the “assignment ID” field. Also, the registration unit 15b specifies a record that the coordinates of four corners of the area are registered among the records of the table 14c_1 with respect to each of the plurality of selected areas, and acquires an ID of the student registered in the “student ID” field of the specified record (S203).

Also, the registration unit 15b registers “1” indicating that the received mark is a mark having a shape similar to a circle in the “type classifying flag” field of the new record added in the handwriting mark coordinate DB 14d by the reception unit 15a (S204).

Also, the registration unit 15b issues a new ID of the group not registered in the “group ID” field of the handwriting mark coordinate DB 14d (S205).

Subsequently, the registration unit 15b specifies a plurality of records that each of the acquired IDs of the plurality of students is registered in the “student ID” field among all the records of the table 14c_1 in which the received ID of the assignment is registered in the “assignment ID” field. Also, the registration unit 15b registers a newly issued ID of the group in the “group ID” field of each of the plurality of specified records (S206).

Also, the registration unit 15b registers the newly issued ID of the group in the “group ID” field of the new record added in the handwriting mark coordinate DB 14d by the reception unit 15 (S207), and stores the processed result in the internal memory and return its control.

In the meantime, when it is determined that the distance between the coordinate of the start point and the coordinate of the end point of the received mark is the predetermined distance or more (“NO” at step S202), the registration unit 15b performs the following process. That is, the registration unit 15b determines whether the acute-angled portion described above exists in the received mark based on the progressed coordinates of the received mark (S208). Determination as to whether the acute-angled portion exists is determined as follows. That is, it is determined whether a portion, where the tendency of the values of X-coordinate and Y-coordinate in the progressed coordinates is largely reversed (from increase to decrease or from decrease to increase), and when the values of X-coordinate and Y-coordinate are largely reversed, exists, it is regarded that an acute-angled portion exists.

When it is determined that the acute-angled portion exists in the received mark (“YES” at step S208), the registration unit 15b performs the following process. That is, the registration unit 15b selects a plurality of areas in which the coordinate of the start point of the received mark is included among the areas specified by the coordinates of four corners registered in the “opinion display area” field of the table 14c_1 in which the received ID of the assignment is registered in the “assignment ID” field. Further, the registration unit 15b selects a plurality of areas in which the coordinate of the end point of the received mark is included among the areas specified by the coordinates of four corners registered in the “opinion display area” field of the table 14c_1 in which the received ID of the assignment is registered in the “assignment ID” field. Further, the registration unit 15b selects a plurality of areas in which the coordinate of the increase/decrease change point of the received mark is included among areas specified by the coordinates of four corners registered in the “opinion display area” field of the table 14c_1 in which the received ID of the assignment is registered in the “assignment ID” field. Also, the registration unit 15b specifies a record that the coordinates of four corners of the area are registered among the records of the table 14c_1 with respect to each of the plurality of selected areas, and acquires an ID of the student registered in the “student ID” field of the specified record (S209).

Also, the registration unit 15b registers “3” indicating that the received mark is a mark including the acute-angled portion in a line in the “type classifying flag” field of the new record added in the handwriting mark coordinate DB 14d by the reception unit 15a (S210), and the registration unit 15b proceeds to step S205.

In the meantime, when it is determined that the acute-angled portion does not exist in the received mark (“NO” at step S208), the received mark is a mark having a line shape and thus, the registration unit 15b performs the following process. That is, the registration unit 15b selects a plurality of areas in which the coordinate of the start point of the received mark is included among areas specified by the coordinates of four corners registered in the “opinion display area” field of the table 14c_1 in which the received ID of the assignment is registered in the “assignment ID” field. Further, the registration unit 15b selects a plurality of areas in which the coordinate of the end point of the received mark is included among areas specified by the coordinates of four corners registered in the “opinion display area” field of the table 14c_1 in which the received ID of the assignment is registered in the “assignment ID” field. Also, the registration unit 15b specifies a record that the coordinates of four corners of the area are registered among the records of the table 14c_1 with respect to each of the plurality of selected areas (two areas), and acquires an ID of the student registered in the “student ID” field of the specified record (S211).

Also, the registration unit 15b registers “2” indicating that the received mark is a mark having a line shape in the “type classifying flag” field of the new record added in the handwriting mark coordinate DB 14d by the reception unit 15a (S212), and the registration unit 15b proceeds to step S205.

Referring back to the description of FIG. 19A and FIG. 19B, when the handwriting display process is performed by the registration unit 15b, the determination unit 15e determines whether a request to end is input from the input unit 11 due to the manipulation of the input unit 11 by the teacher (S116). When it is determined that the request to end is input (“YES” at step S116), the determination unit 15e ends the display process. When it is determined that the request to end is not input (“NO” at step S116), the determination unit 15e goes back to the process of step S110.

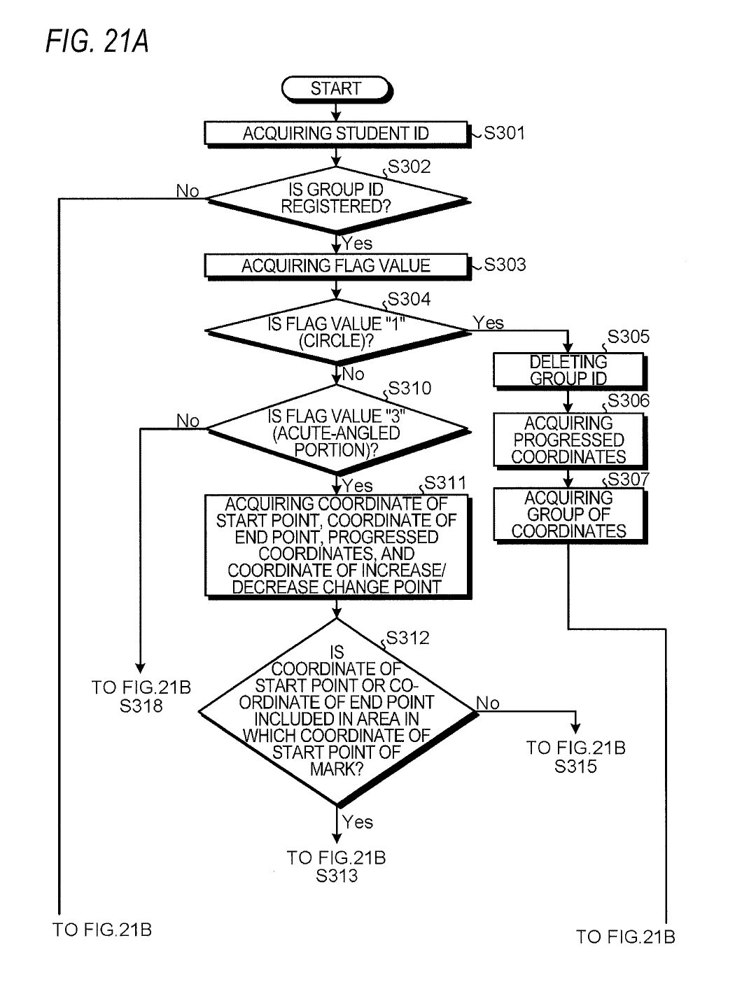

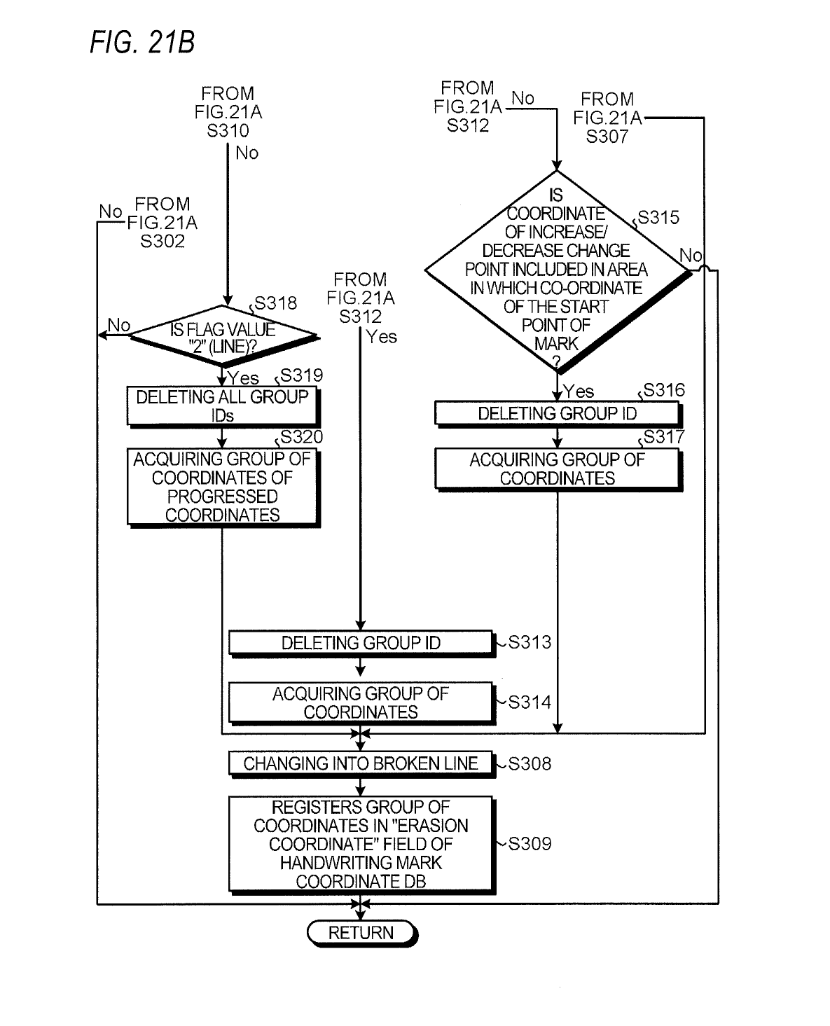

In the meantime, when it is determined that both the value of X-coordinate and the value of Y-coordinate of the acquired progressed coordinates repeat a minute increase or decrease (“YES” at step S112), the release unit 15c performs the erasure process (S117). FIG. 21A and FIG. 21B are flowcharts illustrating a procedural sequence of an erasure process according to the embodiment. As illustrated in an example of FIG. 21A and FIG. 21B, the release unit 15c selects the area in which the coordinate of the start point of the received mark is included among areas specified by the coordinates of the four corners registered in the “opinion display area” field of the table 14c_1 in which the received ID of the assignment is registered in the “assignment ID” field. Also, the registration unit 15b specifies a record that the coordinates of four corners of the area are registered among the records of the table 14c_1, and acquires an ID of the student registered in the “student ID” field of the specified record (S301).

Also, the release unit 15c refers to the “group ID” field of the specified record to determine whether the ID of the group is registered in the “group ID” field (S302). When it is determined that the ID of the group is not registered (“NO” at step S302), the release unit 15c stores the processed result in the internal memory and returns its control. In the meantime, when it is determined that the ID of the group is registered (“YES” at step S302), the release unit 15c specifies a record that the ID of the group determined as being registered is registered in the “group ID” field among all the records of the handwriting mark coordinate DB 14d. Also, the release unit 15c acquires the value of the flag registered in the “type classifying flag” field of the specified record (S303).

Also, the release unit 15c determines whether the acquired value of the flag is “1” (S304). When it is determined that the acquired value of the flag is “1”, the release unit 15c performs the following process. That is, the release unit 15c deletes the ID of the group registered in the “group ID” field of the specified record in the table 14c_1 in which the received ID of the assignment is registered in the “assignment ID” field (S305).

Subsequently, the release unit 15c acquires progressed coordinates associated with a deleted ID from the handwriting mark coordinate DB 14d (S306). Also, the release unit 15c acquires a group of coordinates included in a selected area among the acquired progressed coordinates (S307). Subsequently, the release unit 15c changes a portion of the line segment, which corresponds to the acquired group of coordinates among the line segment of the mark displayed to be overlapped on the opinion displayed in a matrix shape, into a broken line (S308). Also, the release unit 15c registers the acquired group of coordinates in the “erasure coordinate” field associated with the acquired ID of the group among the handwriting mark coordinate DB 14d (S309), and stores the processed result in the internal memory of the control unit 15, and returns its control.

In the meantime, when it is determined that the acquired value of the flag is not “1” (“NO” at step S304), the release unit 15c determines whether the acquired value of the flag is “3” (S310). When it is determined that the acquired value of the flag is “3” (“YES” at step S310), the release unit 15c specifies a record that the ID of the group determined as being registered is registered in the “group ID” among all the records of the handwriting mark coordinate DB 14d. Also, the release unit 15c acquires the coordinate of the start point registered in the “start point coordinate” field of the specified record. Further, the release unit 15c acquires the coordinate of the end point registered in the “end point coordinate” field of the specified record. Further, the release unit 15c acquires the progressed coordinates registered in the “progressed coordinate” field of the specified record. Further, the release unit 15c acquires the coordinate of the increase/decrease change point registered in the “increase/decrease change point” field of the specified record (S311).

Also, the release unit 15c determines whether the acquired coordinate of the start point or the acquired coordinate of the end point is included in an area in which the coordinate of the start point of the received mark is included (S312). When it is determined that the acquired coordinate of the start point or the acquired coordinate of the end point is included in the area in which the coordinate of the start point of the received mark is included (“YES” at step S312), the release unit 15c performs the following process. That is, the release unit 15c deletes the ID of the group registered in “group ID” field of the specified record in the table 14c_1 in which the received ID of the assignment is registered in the “assignment ID” field (S313). Also, the release unit 15c acquires a group of coordinates that falls within a range from the acquired coordinate of the start point or the acquired coordinate of the end point included in the area, in which the coordinate of the start point of the received mark is included, to the nearest coordinate of the increase/decrease change point (S314), and proceeds to step S308.

In the meantime, when it is determined that the acquired coordinate of the start point and the acquired coordinate of the end point are not included in an area in which the coordinate of the start point of the received mark is included (“NO” at step S312), the release unit 15c performs the following process. That is, the release unit 15c determines whether the coordinate of the acquired increase/decrease change point is included in an area in which the coordinate of the start point of the received mark is included (S315). When it is determined that the coordinate of the acquired increase/decrease change point is not included in the area in which the coordinate of the start point of the received mark is included (“NO” at step S315), the release unit 15c stores the processed result in the internal memory of the control unit 15 and returns its control. When it is determined that the coordinate of the acquired increase/decrease change point is included in the area in which the coordinate of the start point of the received mark is included (“YES” at step S315), the release unit 15c performs the following process. That is, the release unit 15c, deletes the ID of the group registered in “group ID” field of the specified record in the table 14c_1 in which the received ID of the assignment is registered in the “assignment ID” field (S316).

Also, the release unit 15c acquires the group of coordinates included in the selected area among the acquired progressed coordinates (S317), and proceeds to step S308.

In the meantime, when it is determined that the acquired value of the flag is not “3” (“NO” at step S310), the release unit 15c determines whether the acquired value of the flag is “2” (S318). When it is determined that the acquired value of the flag is not “2” (“NO” at step S318), the release unit 15c stores the processed result in the internal memory of the control unit 15 and returns its control. When it is determined that the acquired value of the flag is “2” (“YES” at step S318), the release unit 15c performs the following process. That is, the release unit 15c deletes all the IDs of group, that are determined as being registered, among the IDs of group registered in “group ID” field of the specified record in the table 14c_1 in which the received ID of the assignment is registered in the “assignment ID” field (S319).

Also, the release unit 15c specifies a record that the ID of the group determined as being registered is registered in the “group ID” among all the records of the handwriting mark coordinate DB 14d. Also, the release unit 15c acquires the coordinate of the start point registered in the “progressed coordinate” field of the specified record (S320), and proceeds to step S308.

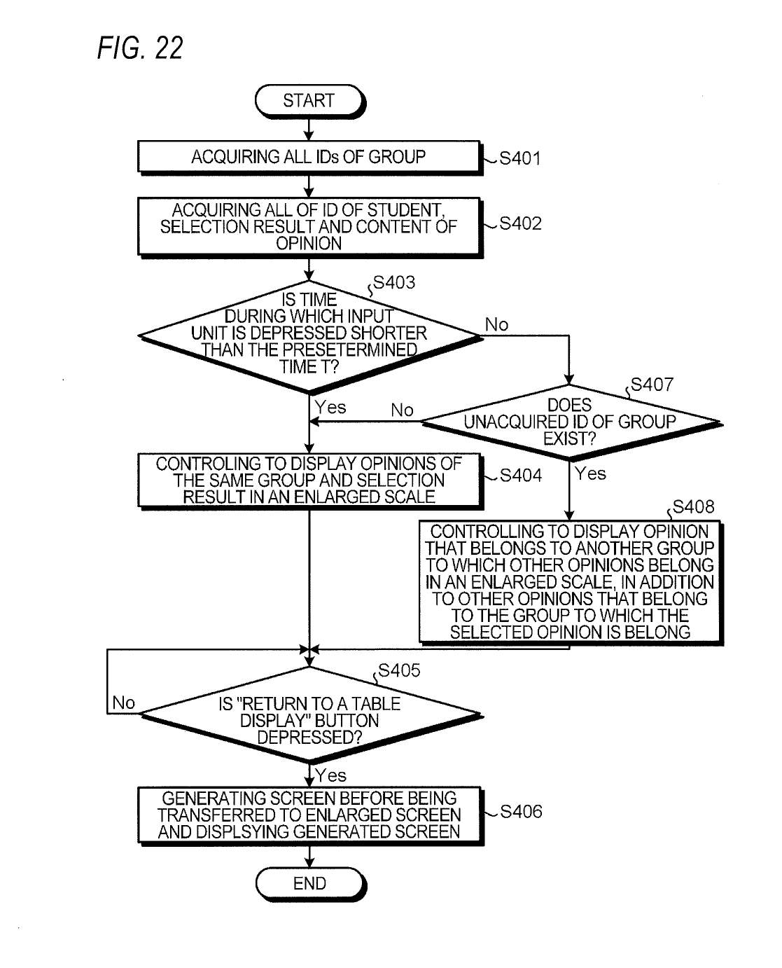

Referring back to the description of FIG. 19A and FIG. 19B, when it is determined that the handwriting input is not done due to the manipulation of a touch pen by the teacher and the manipulation of an electronic pen of the teacher (“NO” at step S110), the display control unit 15d performs the following process. That is, the display control unit 15d determines whether any opinion is selected among a plurality of opinions displayed in a matrix shape due to the depression of the input unit 11 that is a touch panel by the teacher (S118). When it is determined that any opinion is not selected (“NO” at step S118), the display control unit 15d goes back to step S110. When it is determined that any opinion is selected (“YES” at step S118), the display control unit 15d performs the opinion display process (S119). FIG. 22 is a flowchart illustrating a procedural sequence of the opinion display process according to an embodiment. As illustrated in an example of FIG. 22, the display control unit 15d specifies a record that the content of the selected opinion is registered in the “opinion content” among all the records of the table 14c_1 in which the received ID of the assignment is registered in the “assignment ID” field. Also, the display control unit 15d acquires all the IDs of group registered in the “group ID” field of the specified record (S401).

Also, the display control unit 15d specifies all the records that the acquired ID of the group is registered in the “group ID” field among all the records of the table 14c_1 in which the received ID of the assignment is registered in the “assignment ID” field. Subsequently, the display control unit 15d acquires the ID of the student registered in the “student ID” field, a selection result of approval or disapproval registered in the “approval/disapproval” field, the content of opinion registered in the “opinion content” field of each of all the specified records (S402).

Also, the display control unit 15d determines whether a time during which the input unit 11 that is a touch panel is depressed by the teacher is shorter than the predetermined time T (S403). When it is determined that the time during which the input unit 11 that is a touch panel is depressed by the teacher is shorter than the predetermined time T (“YES” at step S403), the display control unit 15d controls the display unit 12 to display the opinion and the selection result of approval or disapproval selected by the teacher in an enlarged scale. Further, the display control unit 15d controls the projector 4b to display the opinion and the selection result of approval or disapproval selected by the teacher on the electronic blackboard 4a in an enlarged scale (S404), and proceeds to step S405.

In the meantime, when it is determined that the time during which the input unit 11 that is a touch panel is depressed by the teacher is the predetermined time T or more (“NO” at step S403), the display control unit 15d performs the following process. That is, the display control unit 15d specifies the acquired record from all the records of the table 14c_1 in which the received ID of the assignment is registered in the “assignment ID” field. Also, the display control unit 15d determines whether a (non-acquired) group ID which is different from the group ID associated with the student ID of the area depressed by the teacher among the IDs of group registered in the “group ID” field of the specified record exists (S407). When it is determined that the unacquired ID of the group does not exist (“NO” at step S407), the display control unit 15d proceeds to step S404.

When it is determined that the unacquired ID of the group exist (“YES” at step S407), the display control unit 15d acquires the unacquired ID of the group. Also, the display controls unit 15d specifies all the records, in which the newly acquired ID of the group is registered in “group ID” field, from all the records of the table 14c_1 in which the received ID of the assignment is registered in the “assignment ID” field. Subsequently, the display controls unit 15d acquires the ID of the student registered in the “student ID” field, a selection result of approval or disapproval registered in the “approval/disapproval” field, the content of opinion registered in the “opinion content” field of each of all the specified records. The display controls unit 15d acquires the student name identified by the acquired ID of the student from the student DB 14a. Also, the display controls unit 15d controls the display unit 12 and the projector 4b to display the acquired selection result, the acquired content of opinion and the acquired student name to be displayed as in the following description. That is, the display controls unit 15d controls the display unit 12 and the projector 4b to display the selection result, the content of opinion and the student name in an enlarged scale (S408).

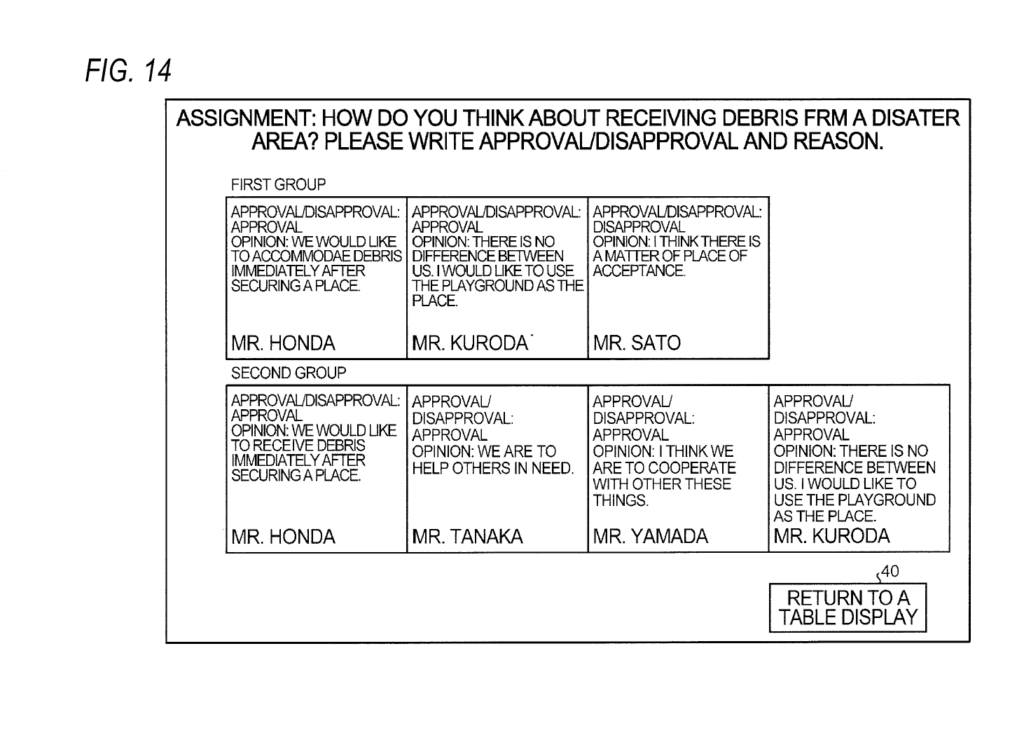

The example of FIG. 9 illustrates a case where the touch panel on the area in which the opinion of the student “Honda” is displayed is depressed by the teacher for a time which is shorter than the predetermined time T. The opinion of the student “Honda” is associated with two groups and thus, as illustrated in an example of FIG. 14, the opinions of the students “Kuroda” and “Sato” that belong to the same group to which the student “Honda” belongs are displayed as a first group, and the opinions of the students “Tanaka”, “Yamada” and “Kuroda” that belong to the same group to which the student “Honda” belongs are displayed as a second group, and the display control unit 15d controls the display unit and the projector to display the first group and the second group together.

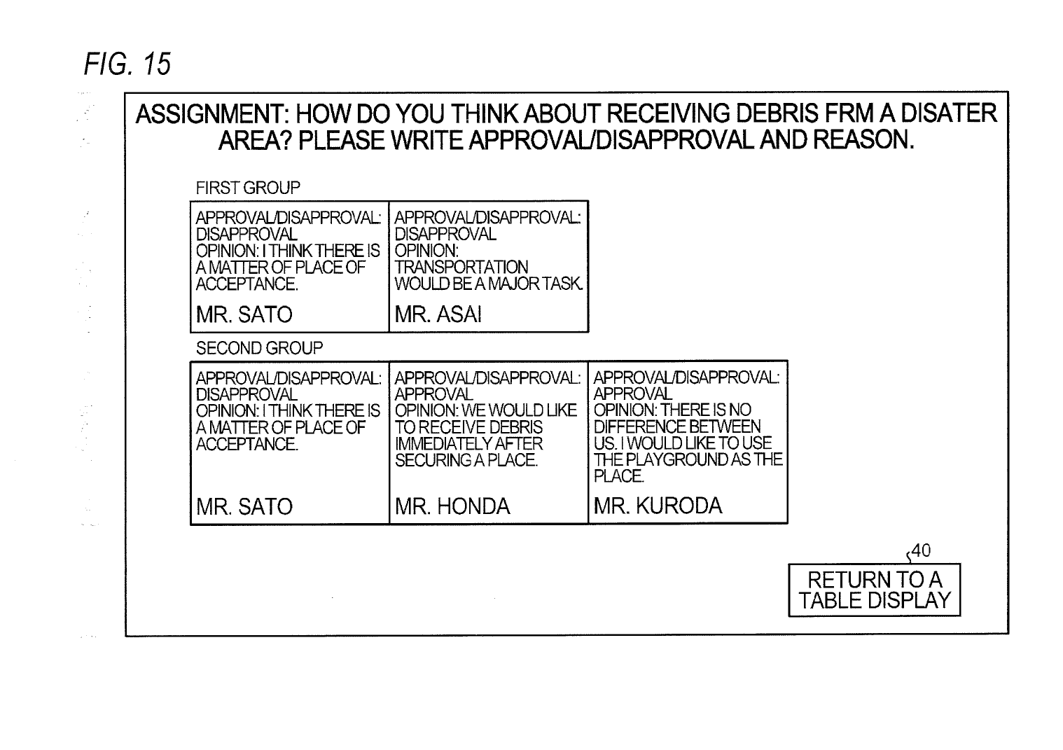

The example of FIG. 9 illustrates a case where the touch panel on the area in which the opinion of the student “Sato” is displayed is depressed by the teacher for a time which is shorter than the predetermined time T. The opinion of the student “Sato” is associated with two groups and thus, as illustrated in an example of FIG. 15, the opinions of the students “Kuroda” and “Honda” that belong to the same group to which the student “Sato” belongs are displayed as a first group, and the opinions of the student “Asai” that belongs to the same group to which the student “Sato” belongs is displayed as a second group, and the display control unit 15d controls the display unit and the projector to display the first group and the second group together.

Also, the display control unit 15d determines whether the “Return to a table display” button 40 is depressed (S405). When it is determined that the “Return to a table display” button 40 is not depressed (“NO” at step S405), the display control unit 15d performs determination of step S405 again. When the “Return to a table display” button 40 is depressed (“YES” at step S405), the display controls unit 15d generates a screen before being transferred to an enlarged screen using registered contents of the assignment reply DB 14c and the handwriting mark coordinate DB 14d, and controls the display unit 12 to display the generated screen. Next, the display controls unit 15d controls the projector 4b to display generated screen on the electronic blackboard 4a (S406). Also, the display control unit 15d stores the processed result in the internal memory of the control unit 15 and returns its control.

As described above, when each of the plurality of opinions is disposed and displayed in a different area among the display area by the display unit 12 and the electronic blackboard 4a, the teacher terminal 2 according to the embodiment receives an input of the mark which is an example of a symbol. When the mark is received, the teacher terminal 2 registers opinions according to the location and/or shape of the mark in the display area among the plurality of opinions by interrelating the opinions with each other. When any of the plurality of opinions is designated, the teacher terminal 2 controls the display unit 12 or the projector 4b to display not only the designated opinion but also other opinions, in a case where the other opinions that belong to the same group to which the designated opinion belongs exist. Therefore, according to the teacher terminal 2, the plurality of interrelated opinions may be collectively displayed in an enlarged scale without performing setting to select and display the plurality of opinions sequentially in an enlarged scale. Accordingly, according to the teacher terminal 2, the convenience in displaying a plurality of data may be increased.

Further, when a distance between the position of the start point and the position of the end point of the mark is the predetermined distance or more, the teacher terminal 2 determines that the mark has a line shape, and registers an opinion disposed at an area in which the position of the start point of the mark is located and an opinion disposed at an area in which the position of the end point of the mark is located by interrelating the opinions with each other. By doing this, the opinions displayed at the positions of both ends of the mark may be interrelated with each other.

Further, when an increase/decrease change point is included among the progressed coordinates of the mark, the teacher terminal 2 registers an opinion disposed at an area in which the increase/decrease change point by further interrelating the opinion. By doing this, it is possible to interrelate the opinion displayed at the area in which the increase/decrease change point is located with other opinions.

Further, when the distance between the position of the start point and the position of the end point of the mark is less than the predetermined distance, the teacher terminal 2 determines that a plurality of areas are designated by a mark having a circular shape and registers the opinions disposed at the area in which the mark is located by interrelating the opinions. By doing this, it is possible to interrelate all the opinions disposed throughout the entire area at which the mark is located.

Further, when the received mark has a shape in which both the X-coordinate and the Y-coordinate repeat a minute increase or decrease, the teacher terminal 2 releases the interrelation of the opinions displayed at the area in which the mark is located in the display area. By doing this, it is possible to release an interrelation of some opinions.

Further, in the teacher terminal 2, an opinion that belongs to another group to which the other opinions belong is also displayed in an enlarged scale, in addition to the other opinions that belong to the same group to which the selected opinion is belong, according to a time during which an area in which an opinion is continuously touched. Accordingly, according to the teacher terminal 2, it is possible to change the scope of the opinions to be displayed in an enlarged scale according to the continuously touched time.

While descriptions have been made on the embodiments of the disclosed apparatus, the present disclosure may be embodied in a variety of modifications in addition to the embodiments described above.

For example, the mark described above may be various shapes, such as a character, a symbol or a figure.

For example, all or some of processes described as performed automatically among the respective processes described in each embodiment may be performed manually. Further, all or some of processes described as being performed manually among the respective processes described in each embodiment may be performed automatically by a well-known method.

Further, it is possible to arbitrarily divide processing in each step of each process described in each embodiment into sub-processing or integrate the processing depending on various loads or use situations. Further, one or more of the steps may be omitted.

Further, a processing sequence in each step of each process described in each embodiment may be changed depending on various loads or use situations.

Further, each constituent of each device illustrated is a functional and/or conceptual component, and may not be required necessarily to have physically the same configuration as illustrated one. That is, specifics of distribution and/or integration of the devices is not limited to the illustrated specifics, and all or some of the specifics may be configured by distributing and/or integrating the devices functionally or physically at an any unit depending on various loads or use situations.

[Display Process Program]

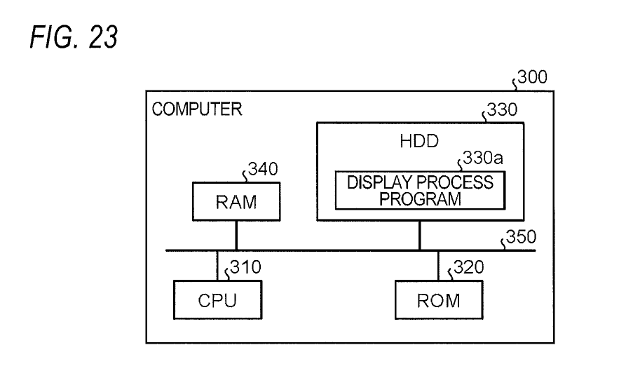

Further, various processes of the teacher terminal 2 described in the embodiments described above may be realized by allowing a program prepared in advance to be executed in a computer system such as a personal computer or a work station. Accordingly, in the following description, an example of a computer which executes a display process program and has the same function as the teacher terminal 2 described in the embodiment, will be described with reference to FIG. 23. FIG. 23 is a view illustrating a computer that executes the display processing program.

As illustrated in FIG. 23, a computer 300 may include a CPU 310, a ROM 320, a HDD (Hard Disk Drive) 330 and a RAM 340. These equipments 310 to 340 may be connected with one another through, for example, a bus 350.

A basic program such as an Operating System (OS) may be stored in the ROM 320. Further, a display process program 330a which implements the same function as that of the reception unit 15a or the display control unit 15b may be stored in the HDD 330 in advance. Further, various DBs stored in the storage unit 14 may be stored in the HDD 330.

Also, the CPU 310 may read out the display process program 330a from the HDD 330 and execute the display process program 330a.

Also, the CPU 310 may read out and store various DBs from and in the RAM 340. Further, the CPU 310 may execute the display process program 330a using various DBs stored in the RAM 340. Further, data intended to be stored in the RAM 340 may not always be stored in its entirety in the RAM 340 as long as the data to be used for executing the process is stored in the RAM 340.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A display processing apparatus, comprising:
a reception unit configured to receive an input of a symbol when each of a plurality of data is disposed and displayed on a different area among display areas by a display device;
a registration unit configured to register a group of data according to at least one of a position and a shape of the symbol in the display area among data included in the plurality of data when the symbol is received by the reception unit; and
a display control unit configured to control the display device to display all data included in the registered group of data which includes designated data, when any of data included in the plurality of data is designated and the designated data is included in the registered group of data.

2. The display processing apparatus according to claim 1, wherein the registration unit is configured to register data disposed at an area in which a start point of the symbol is located and data disposed at an area in which an end point of the symbol is located when a distance between a position of the start point and a position of the end point of the symbol received by the reception unit is larger than a predetermined value.

3. The display processing apparatus according to claim 2, wherein the registration unit is configured to additionally register data disposed at an area in which a first shape is located when the first shape is included in the symbol.

4. The display processing apparatus according to claim 1, wherein the registration unit is configured to additionally register a group of data disposed at an area in which the symbol is located when the distance between the position of the start point and the position of the end point of the symbol is the predetermined value or less.

5. The display processing apparatus according to claim 1, further comprising a release unit configured to release a registration of data according to the position of the symbol in the display area among the registered data when the symbol received by the reception unit is a second shape.

6. The display processing apparatus according to claim 1, wherein the display control unit is configured to control the display device to display other group of data, in which each data included in a group of data in which the designated data is registered, is registered together with each data included in the group of data according to a time during which the area in which the designated data is displayed is continuously touched.

7. The display processing apparatus according to claim 1, the symbol is any of a character, a symbol or a figure.

8. A system, comprising:
a display device; and
a terminal,
wherein the display device includes a display unit configured to perform displaying according to an instruction from the terminal,
the terminal includes;
a first display control unit configured to transmit a first instruction that instructs to dispose and display each of a plurality of data on a different area among display areas to the display device, and control displaying of the display device;
a reception unit configured to receive an input of a symbol when the first instruction is transmitted to the display device by the first display control unit and each of the plurality of data is disposed and displayed on a different area among display areas by the display device;
a registration unit configured to register a group of data according to at least of a position and a shape of the symbol in the display area among data included in the plurality of data when the symbol is received by the reception unit; and
a second display control unit configured to transmit a second instruction, that instructs to display other data included in the group of data together with the designated data, to the display device when any of data included in the plurality of data is designated and the designated data is included in the registered group of data, together with the designated data, and control display of the display device.

9. A non-transitory computer-readable storage medium storing therein a program that causes a computer to execute a process, the process comprising:
receiving an input of a symbol when each of a plurality of data is disposed and displayed on a different area among display areas;
registering a group of data according to at least a position and a shape of the symbol in a display area of a display device among data included in the plurality of data when the symbol is received; and
controlling the display device to display other data included in the group of data, when any of data included in the plurality of data is designated and the designated data is included in the registered group of data, together with the designated data.

10. The non-transitory computer-readable storage medium according to claim 9, the process further comprising:
registering data disposed at an area in which a start point of the symbol is located and data disposed at an area in which an end point of the symbol is located when a distance between a position of the start point and a position of the end point of the symbol received is larger than a predetermined value.

11. The non-transitory computer-readable storage medium according to claim 10, the process further comprising:
registering data disposed at an area in which a first shape is located when the first shape is included in the symbol.

12. The non-transitory computer-readable storage medium according to claim 9, the process further comprising:
registering a group of data disposed at an area in which the symbol is located when the distance between the position of the start point and the position of the end point of the symbol is the predetermined value or less.

13. The non-transitory computer-readable storage medium according to claim 9, the process further comprising:
releasing a registration of data according to the position of the symbol in the display area among the registered data when the symbol received is a second shape.

14. The non-transitory computer-readable storage medium according to claim 9, the process further comprising:
controlling the display device to display other group of data, in which each data included in a group of data in which the designated data is registered, is registered together with each data included in the group of data according to a time during which the area in which the designated data is displayed is continuously touched.

15. The non-transitory computer-readable storage medium according to claim 9,
wherein the symbol is any of a character, a symbol or a figure.
